(19) United States
(12) Patent Application Publication
(10) Pub. No.: US 2025/0044001 A1
(43) Pub. Date: Feb. 6, 2025

(54) MULTI-STAGE ADSORBER DEVICE AND USES THEREOF FOR CHILLING AND/OR ATMOSPHERIC WATER HARVESTING

(71) Applicant: Freshape SA, Renens (CH)

(72) Inventors: Chin Lee Ong, Ecublens (CH); Mathieu Rubi, Ecublens (CH)

(21) Appl. No.: 18/715,457

(22) PCT Filed: Dec. 2, 2021
(86) PCT No.: PCT/IB2021/061229

§ 371 Date: May 31, 2024

(51) Int. Cl. F25B 37/00; F25B 17/08; F25B 39/02

(52) U.S. Cl. CPC F25B 37/00; F25B 17/08; F25B 39/026

(57) ABSTRACT

A multi-stage adsorber device including a plurality of adsorption stages distributed in sequence, each including an adsorber coupled to an adjacent vapor chamber, wherein the adsorber of each following adsorption stage is thermally coupled to the vapor chamber of a preceding adsorption stage via a heat transfer structure. A heating stage is thermally coupled to a first one of the adsorption stages to selectively provide thermal energy to the adsorbers, while a cooling stage is thermally coupled to a final one of the adsorption stages to selectively cause condensation of desorbed vapor in the vapor chambers. The adsorber device further includes a cooling circuit having first and second cooling sections to selectively cause circulation of a cooling fluid through the cooling stage and through each of the adsorbers, respectively. During a desorption cycle, the heating stage is activated to induce vapor desorption in the adsorbers, resulting in desorbed vapor flowing from each adsorber into the adjacent vapor chamber, and cooling fluid circulates exclusively through the cooling stage via the first cooling section. As a result, desorbed vapor condenses along a surface of the heat transfer structure, during the desorption cycle, releasing latent heat that is transferred to the adsorber of the following adsorption stage. During an adsorption cycle, the heating stage is deactivated to allow vapor adsorption into the adsorbers, and cooling fluid circulates through both the cooling stage and each of the adsorbers via the first and second cooling sections. Uses of such adsorber device are especially contemplated for chilling and/or atmospheric water harvesting applications.

### TECHNICAL FIELD

The present invention generally relates to a multi-stage adsorber device and uses thereof for chilling and/or atmospheric water harvesting (AWH).

### BACKGROUND OF THE INVENTION

Global warming, the main driver of climate change has become a reality. The consequences of climate change, amplified by economic, demographic and social challenges are exerting an enormous amount of pressure on our global energy demand. The energy-water-food nexus, defined as the relationship between energy, water and food security is inextricable. Energy security, affected by climate change, thus affects in turn food and water security, threatening human population and the well-being of the ecosystem we rely on.

To alleviate these issues and ensure continuous economical development, we are more than ever dependent on fossil fuels for power generation. Today, nearly 84% of the energy on Earth comes from fossil fuel resources. Forecasts estimate that the global energy consumption will increase by 71% from 2003 to 2030 (see e.g. “Applications of solar energy for domestic hot-water and building heating/cooling”, loan Sarbu et al., International Journal of Energy, Issue 2, Vol. 5, pp. 34-42, 2011). Energy crisis is already affecting the sustainability of the global economic development and there is a need to improve energy utilization ratio. Moreover, water and energy systems are interdependent on each other as water is used in basically all phases of energy production and electricity generation.

Fresh water scarcity is increasingly affecting human population and more and more people are suffering from restrictions to potable water access, which problem is growing day by day. By 2025, it is estimated that approximately 1.8 billion people will be living in absolute water scarcity regions, while two thirds of the world's population will be living under water stressed conditions. By 2030, half of the world's population could be living under high water stress, i.e. without access to clean, fresh and safe drinking water. Furthermore, energy is required to extract, convey, and deliver water of appropriate quality for diverse human uses, and then again to treat wastewaters prior to their return to the environment.

Cooling/refrigeration, and air conditioning especially, is necessary for sustaining a “luxurious” life and will continue to expand worldwide. Cooling/refrigeration equipments all consume electricity, adding to the aforementioned energy crisis and contributing more generally to climate change. It is estimated that usage of air conditioners and electric fans for cooling applications today account for about a fifth of all the electricity used in buildings globally, or approximately 10% of today's global electricity consumption (see “The Future of Cooling—Opportunities for energy-efficient air conditioning”, IEA Publications, International Energy Agency (IEA), May 2018).

Electricity is considered as “high-grade” energy. It can easily be transported to any location with minimal losses. Moreover, electricity can readily be converted into any form of energy, including pressure, potential, kinetic, mechanical, thermal, etc. Constant power blackouts across major cities during peak demands, e.g. in summer, are becoming more frequent, and increase in air condition equipment usage is key contributor to such power blackouts.

Energy, water and food are necessities to sustain human life. Cooling/refrigeration, on the other hand, is a luxury. Hence, consuming valuable high-grade electrical energy for cooling/refrigeration applications such as air conditioning is a gross misuse of energy resources.

FIG. 1 is a schematic flow diagram of a typical vapor compression refrigeration cycle, which is the most widely used technology for cooling/refrigeration applications, and air conditioning more specifically. The main components of a typical vapor compression chiller include (i) an evaporator, (ii) a condenser, (iii) a compressor and (iv) an expansion valve system. Vapor compression chillers in general have many advantages, including:
a large cooling capacity with minimal amount of refrigeration mass flow;
arguably, superior efficiency, with a particularly high coefficient of performance (COP); and
the ability to cool down to sub-ambient conditions.

Vapor compression chillers also have a number of disadvantages, most notably:
they require use of specific liquid compounds, or refrigerants, including hydrofluorocarbon (HFC) refrigerants which contribute to climate change, as well as chlorofluorocarbon (CFC) and hydrochlorofluorocarbon (HCFC) refrigerants (now banned in most countries), which contribute to depletion of the ozone layer;
they operate less efficiently when their size becomes smaller due to a lower refrigerant charge, smaller channels contributing to comparatively higher frictional pressure drop and thermodynamic losses; and
they consume “high grade” energy, namely electricity that is still largely generated by burning fossil fuels that contributes to carbon dioxide emissions, a major contributor to greenhouse gases emissions leading to climate change and global warming.

FIG. 2 is a schematic diagram of a so-called adsorption chiller, which constitutes an alternative to the use the aforementioned vapor compression chiller technology. Adsorption chillers capitalize on the adsorption process, whereby fluid molecules of the adsorbate are attached on the micro-pores of a solid porous adsorbent material. FIG. 2 more specifically shows an adsorption chiller of the dual-bed configuration type, i.e. comprising two adsorbent beds that are operated in an alternate manner to undergo successive adsorption and desorption cycles. During the adsorption cycle, vapor evaporates from a pool of refrigerant (the adsorbate) in contact with an evaporator, inducing evaporative cooling in the process. Coolant (such as water), circulating in a separate loop, flows through the evaporator before exiting the evaporator as chilled coolant, used e.g. for space cooling. Vapor generated by the evaporator is adsorbed by the first adsorbent bed which is typically cooled to enhance adsorption efficiency. While the first adsorbent bed undergoes adsorption, the second adsorbent bed undergoes the desorption cycle. More specifically, the second adsorbent bed is heated to induce vapor desorption, resulting in desorbed vapor being released from the second adsorbent bed to a condenser where the desorbed vapor condenses into a condensate that is returned to the pool of refrigerant. Latent heat resulting from the condensation is transferred to a fluid that circulates through the condenser for subsequent heat rejection. Operation of each adsorbent bed is alternated and cycled between successive adsorption and desorption cycles to sustain cooling.

Adsorption chilling is a very promising technology and has many advantages, most notably:
use of eco-friendly refrigerants, such as water, ethanol, methanol, etc.;
operation simplicity;
less moving parts and vibrations;
low-cost maintenance;
the ability to be driven by renewable thermal energy sources (e.g. solar thermal energy), low-grade heat and/or waste heat input from industrial processes.

Currently available adsorption chillers are not however as efficient as vapor compression chillers and exhibit a comparatively low coefficient of performance (COP). Poor heat and mass transfer characteristics between adsorbent and adsorbate also lead to low energy efficiency and, as a result, high specific energy consumption. These chillers also suffer from a low Specific Cooling Power (SCP), hence require huge adsorbent mass and bulky adsorbent beds/adsorbers. Current adsorption chillers are therefore heavy and bulky in size, also due to the necessity to perform intermittent, discontinuous cooling during operation. Inefficient evaporator design also affects the overall performance of adsorption chillers.

In effect, current adsorption chillers as commercially available are incapable of replacing existing vapor compression systems due to their low COP which typically remains below 0.75. Such technology may become a viable and competitive alternative if successful breakthroughs are achieved in terms of specific energy consumption allowing a COP of above 1.

There are several types of adsorption chillers in the art, including single-bed, dual-bed or multi-bed configurations. Reviews of existing adsorption chiller concepts are provided in the following literature:
“Review and future trends of solar adsorption refrigeration systems”, M. S. Fernandes et al., Renewable and Sustainable Energy Reviews, 5 Volume 39, pp. 102-123, November 2014;
“A review on adsorption cooling systems with silica gel and carbon as adsorbents”, R. P. Sah et al., Renewable and Sustainable Energy Reviews, Volume 45, pp. 123-134, May 2015; and
“Review on improvement of adsorption refrigeration systems performance using composite adsorbent: current state of art”, P. Soni et al., Energy Sources, Part A: Recovery, Utilization, and Environmental Effects, May 21, 2021.

There therefore remains a need for an improved solution.

### SUMMARY OF THE INVENTION

A general aim of the invention is to provide an adsorber device that can be used e.g. as chiller device and that obviates the limitations and drawbacks of the prior art solutions.

More specifically, an aim of the present invention is to provide such a solution that is highly efficient and moreover cost-efficient to implement and operate.

A further aim of the invention is to provide such a solution that is modular and easily up-scalable to increase and adjust system throughput to the required needs.

Another aim of the invention is to provide such a solution that ensures efficient heat recovery for carrying out desorption.

Yet another aim of the invention is to provide such a solution that exhibits lower systemic energy consumption requirements (both electrical and thermal) and minimizes thermodynamic losses.

A further aim of the invention is to provide such a solution that can be used not only for chilling applications, but also for other applications such as atmospheric water harvesting (AWH).

Another aim of the invention is to provide such a solution that can suitably be combined and integrated with renewable energy sources, in particular solar energy, and/or make optimal use of waste heat from industrial processes.

These aims, and others, are achieved thanks to the solutions defined in the claims.

There is accordingly provided a multi-stage adsorber device, the features of which are recited in claim 1, namely a multi-stage adsorber device comprising:
a plurality of adsorption stages distributed in sequence, each adsorption stage including an adsorber coupled to an adjacent vapor chamber, wherein the adsorber of each following adsorption stage is thermally coupled to the vapor chamber of a preceding adsorption stage via a heat transfer structure;
a heating stage thermally coupled to a first one of the adsorption stages to selectively provide thermal energy to the adsorbers;
a cooling stage thermally coupled to a final one of the adsorption stages to selectively cause condensation of desorbed vapor in the vapor chambers; and
a cooling circuit having a first cooling section to cause circulation of a cooling fluid through the cooling stage and a second cooling section to cause selective circulation of the cooling fluid through each of the adsorbers,
wherein, during a desorption cycle of the multi-stage adsorber device, the heating stage is activated to induce vapor desorption in the adsorbers resulting in desorbed vapor flowing from each adsorber into the adjacent vapor chamber,
wherein each heat transfer structure is configured to cause condensation of the desorbed vapor along a surface of the heat transfer structure, during the desorption cycle of the multi-stage adsorber device, such that latent heat resulting from the condensation of the desorbed vapor is transferred to the adsorber of the following adsorption stage,
wherein, during an adsorption cycle of the multi-stage adsorber device, the heating stage is deactivated to allow vapor adsorption into the adsorbers,
wherein the cooling circuit is configured to cause circulation of the cooling fluid only through the first cooling section during the desorption cycle of the multi-stage adsorber device,
and wherein the cooling circuit is further configured to cause circulation of the cooling fluid through both the first and second cooling sections during the adsorption cycle of the multi-stage adsorber device.

Thanks to the invention, high efficiency is achieved during each desorption cycle thanks to latent heat resulting from condensation of the desorbed vapor against the heat transfer structures being exploited to re-heat the adsorbers of the following adsorption stages. Furthermore, rapid cooling is achieved during each adsorption cycle thanks to circulation of the cooling fluid through each of the adsorbers, bringing down the temperature of the adsorbent to the desirable adsorption temperature for enhanced adsorption efficiency.

Various preferred and/or advantageous embodiments of this multi-stage adsorber device form the subject-matter of dependent claims 2 to 12.

Also claimed is the use of the multi-stage adsorber device of the invention for chilling or for atmospheric water harvesting (AWH).

There is also claimed a chiller apparatus comprising a multi-stage adsorber device in accordance with the invention acting as chiller device, a coolant reservoir to supply cooling fluid to the multi-stage adsorber device, and an evaporator to supply vapor to the adsorption stages during the adsorption cycle of the multi-stage adsorber device.

Various preferred and/or advantageous embodiments of this chiller apparatus form the subject-matter of dependent claims 16 to 25.

There is further provided a chiller system as recited in claim 26, namely a chiller system comprising:
a first chiller module and a second chiller module each comprising at least one multi-stage adsorber device in accordance with the invention acting as chiller device;
a coolant reservoir to supply cooling fluid to the first and second chiller modules;
an evaporator to selectively supply vapor to the first chiller module or the second chiller module; and
a radiator that is coupled to the coolant reservoir and to the evaporator for re-cooling of warm cooling fluid coming from the coolant reservoir,
wherein the chiller system is configured such that, when the first chiller module undergoes the adsorption cycle, the second chiller module undergoes the desorption cycle, and vice versa, and
wherein the chiller system is further configured such that:
cooling fluid is supplied from the coolant reservoir through the radiator to the first chiller module or the second chiller module depending on whether the first chiller module or the second chiller module undergoes the adsorption cycle;
cooling fluid is supplied from the coolant reservoir to the first chiller module or the second chiller module depending on whether the first chiller module or the second chiller module undergoes the desorption cycle;
cooling fluid is returned from the first chiller module and the second chiller module to the coolant reservoir;
vapor is supplied from the evaporator to the first chiller module or the second chiller module depending on whether the first chiller module or the second chiller module undergoes the adsorption cycle; and
condensate formed as a result of condensation in the first chiller module or the second chiller module, when undergoing the desorption cycle, is returned to the coolant reservoir.

Various preferred and/or advantageous embodiments of this chiller system form the subject-matter of dependent claims 27 to 32.

There is also claimed an atmospheric water harvesting (AWH) apparatus comprising a multi-stage adsorber device in accordance with the invention acting as atmospheric water harvesting device, a coolant reservoir to supply cooling fluid to the multi-stage adsorber device, and an ambient air intake to feed humid air to the adsorption stages of the multi-stage adsorber device during the adsorption cycle of the multi-stage adsorber device.

Preferably, the ambient air intake is coupled to vapor chambers of the adsorption stages of the multi-stage adsorber device through a throttle valve that is selectively activated during the adsorption cycle of the multi-stage adsorber device to allow humid air to be supplied to the adsorption stages of the multi-stage adsorber device. During the desorption cycle of the multi-stage adsorber device, the throttle valve is selectively activated to allow condensate forming in the vapor chambers of the adsorption stages to be collected in the coolant reservoir.

There is further provided an atmospheric water harvesting system as recited in claim 35, namely an atmospheric water harvesting system comprising:
two or more multi-stage adsorber devices in accordance with the invention each acting as an atmospheric water harvesting device;
a coolant reservoir to supply cooling fluid to each multi-stage adsorber device;
an ambient air intake to selectively feed humid air to the multi-stage adsorber devices; and
a radiator that is coupled to the coolant reservoir for re-cooling of warm cooling fluid coming from the coolant reservoir,
wherein the atmospheric water harvesting system is configured such that only one of said multi-stage adsorber devices undergoes the desorption cycle at any given time, while all remaining multi-stage adsorber devices undergo the adsorption cycle, and
wherein the atmospheric water harvesting system is further configured such that:
cooling fluid is supplied from the coolant reservoir through the radiator to each multi-stage adsorber device undergoing the adsorption cycle;
cooling fluid is supplied from the coolant reservoir to the multi-stage adsorber device undergoing the desorption cycle;
cooling fluid is returned from the multi-stage adsorber devices to the coolant reservoir;
humid air is fed from the ambient air intake to each multi-stage adsorber device undergoing the adsorption cycle; and
condensate formed as a result of condensation in the multi-stage adsorber device undergoing the desorption cycle is returned to the coolant reservoir.

Various preferred and/or advantageous embodiments of this atmospheric water harvesting apparatus form the subject-matter of dependent claims 36 to 42.

There is further provided a combined chiller and atmospheric water harvesting system as recited in claim 43, namely a combined chiller and atmospheric water harvesting system comprising:
a first pair of multi-stage adsorber devices in accordance with the invention acting as chiller devices and a second pair of multi-stage adsorber devices in accordance with the invention acting as atmospheric water harvesting devices;
a coolant reservoir to supply cooling fluid to each multi-stage adsorber device;
an evaporator to selectively supply vapor to one or the other multi-stage adsorber device of the first pair of multi-stage adsorber devices;
an ambient air intake to selectively feed humid air to one or the other multi-stage adsorber device of the second pair of multi-stage adsorber devices;
a radiator that is coupled to the coolant reservoir and to the evaporator for re-cooling of warm cooling fluid coming from the coolant reservoir; and
a condensate tank to collect condensate produced by each multi-stage adsorber device of the second pair of multi-stage adsorber devices,
wherein the combined chiller and atmospheric water harvesting system is configured such that, when one multi-stage adsorber device of the first pair of multi-stage adsorber devices undergoes the adsorption cycle, the other multi-stage adsorber device undergoes the desorption cycle and such that, when one multi-stage adsorber device of the second pair of multi-stage adsorber devices undergoes the adsorption cycle, the other multi-stage adsorber device undergoes the desorption cycle, and
wherein the combined chiller and atmospheric water harvesting system is further configured such that:
cooling fluid is supplied from the coolant reservoir through the radiator to each multi-stage adsorber device undergoing the adsorption cycle;
cooling fluid is supplied from the coolant reservoir to each multi-stage adsorber device undergoing the desorption cycle;
cooling fluid is returned from the multi-stage adsorber devices to the coolant reservoir;
vapor is supplied from the evaporator to that multi-stage adsorber device of the first pair of multi-stage adsorber devices which undergoes the adsorption cycle;
condensate formed as a result of condensation in that multi-stage adsorber device of the first pair of multi-stage adsorber devices which undergoes the desorption cycle is returned to the coolant reservoir,
humid air is fed from the ambient air intake to that multi-stage adsorber device of the second pair of multi-stage adsorber devices which undergoes the adsorption cycle; and
condensate formed as a result of condensation in that multi-stage adsorber device of the second pair of multi-stage adsorber devices which undergoes the desorption cycle is collected into the condensate tank.

Various preferred and/or advantageous embodiments of this combined chiller and atmospheric water harvesting system form the subject-matter of dependent claims 44 to 46.

There is further provided a method of carrying out multi-stage adsorption, the features of which are recited in independent claim 47, namely such a method comprising the following steps:
(a) providing at least one multi-stage adsorption module designed to operate in alternate desorption and adsorption cycles, the multi-stage adsorption module including two or more successive adsorption stages each comprising an adsorber coupled to an adjacent vapor chamber, wherein the adsorber of each following adsorption stage is thermally coupled to the vapor chamber of a preceding adsorption stage via a heat transfer structure;
(b) operating the multi-stage adsorption module in the desorption cycle by supplying thermal energy to the adsorber of at least a first one of the adsorption stages to induce vapor desorption and taking thermal energy away from the adsorber of a final one of the adsorption stages to cause condensation of desorbed vapor, whereby desorbed vapor is released by each adsorber and flows to each adjacent vapor chamber where it condenses along a surface of each heat transfer structure, thereby releasing latent heat that is transferred to the adsorber of each following adsorption stage to sustain vapor desorption; and
(c) operating the multi-stage adsorption module in the adsorption cycle by ceasing all supply of thermal energy to the adsorber of the first one of the adsorption stages and taking thermal energy away from the adsorbers of all adsorption stages to cool the adsorbers and sustain adsorption.

The method of the invention may especially be applied for the purpose of chilling or for the purpose of atmospheric water harvesting (AWH).

Lastly, there is further provided an evaporator suitable for use in the context of the invention, the features of which are recited in independent claim 50, namely an evaporator comprising a heat exchanger structure configured to allow transfer of heat from a heat source, a porous wick structure thermally coupled to the heat exchanger structure, which porous wick structure is configured to be wettable by a liquid cooling medium, and a coolant dispensing system configured to wet the porous wick structure by means of the liquid cooling medium, wherein the porous wick structure is structured to be partly exposed to vapor flow to cause part of the liquid cooling medium to evaporate.

Various preferred and/or advantageous embodiments of this evaporator form the subject-matter of dependent claims 51 to 60.

Further advantageous embodiments of the invention are discussed below.

### BRIEF DESCRIPTION OF THE DRAWINGS

Other features and advantages of the present invention will appear more clearly from reading the following detailed description of embodiments of the invention which are presented solely by way of non-restrictive examples and illustrated by the attached drawings in which:

FIG. 1 is a schematic flow diagram illustrating operation of a known vapor compressor refrigeration cycle;

FIG. 2 is a schematic diagram of a known adsorption chiller;

FIG. 3 is a schematic diagram of a multi-stage adsorber device in accordance with a preferred embodiment of the invention;

FIG. 3A is a schematic diagram of the multi-stage adsorber device of FIG. 3 depicting operation thereof during a desorption cycle;

FIG. 3B is a schematic diagram of the multi-stage adsorber device of FIG. 3 depicting operation thereof during an adsorption cycle;

FIG. 4 is a schematic diagram of an illustrative example of a quad-adsorber bed chiller system in accordance with an embodiment of the invention;

FIG. 5 is a schematic diagram of an illustrative example of a dual-adsorber bed chiller system in accordance with another embodiment of the invention;

FIG. 6 is a schematic diagram of an illustrative example of a quad-adsorber bed atmospheric water harvesting (AWH) system in accordance with an embodiment of the invention;

FIG. 7 is a schematic diagram of an illustrative example of a dual-adsorber bed atmospheric water harvesting (AWH) system in accordance with another embodiment of the invention;

FIG. 8 is a schematic diagram of an illustrative example of a quad-adsorber bed hybrid system for combined chilling and atmospheric water harvesting (AWH) in accordance with an embodiment of the invention;

FIG. 9A is a schematic diagram illustrating the known principle of an immersed evaporator;

FIG. 9B is a schematic diagram illustrating the know principle of a spray evaporator;

FIG. 10 is an explanatory illustration showing wetting of a porous wick structure of an evaporator in accordance with an embodiment of the invention;

FIG. 10A is an explanatory illustration showing the wetted porous wick structure of FIG. 10 undergoing evaporation;

FIG. 11 is a schematic perspective view of an evaporator in accordance with a preferred embodiment of the invention;

FIGS. 11A and 11B are partial perspective views showing cross-sections of the evaporator of FIG. 11; and

FIG. 12 is a perspective view showing an alternate configuration of a porous wick structure, namely, a pin-fin structure, usable as part of an evaporator in accordance with another embodiment of the invention.

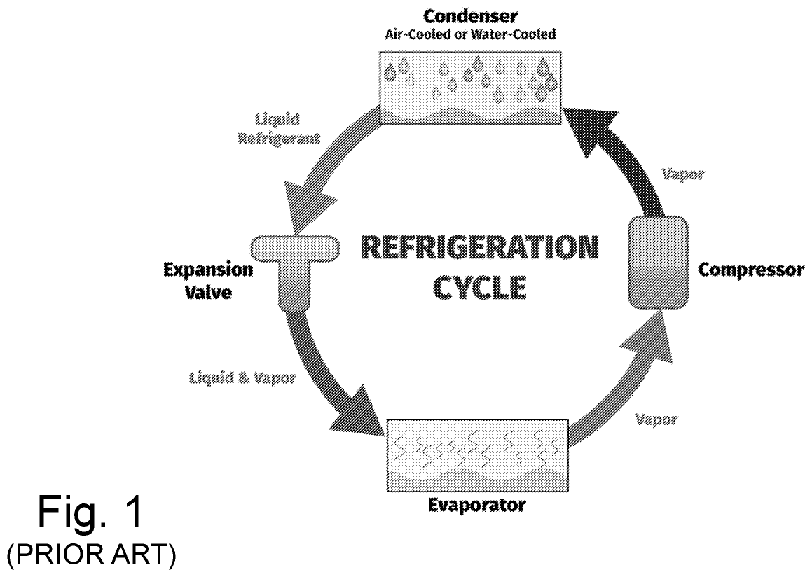

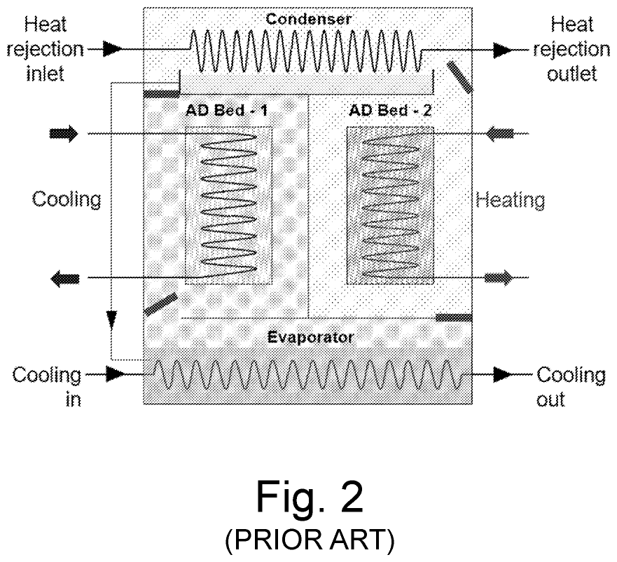

### DETAILED DESCRIPTION OF EMBODIMENTS OF THE INVENTION

The present invention will be described in relation to various illustrative embodiments. It shall be understood that the scope of the invention encompasses all combinations and sub-combinations of the features of the embodiments disclosed herein.

As described herein, when two or more parts or components are described as being connected, attached, secured or coupled to one another, they can be so connected, attached, secured or coupled directly to each other or through one or more intermediary parts.

Embodiments of the multi-stage adsorber device, uses thereof, as well as the related adsorption method of the invention will especially be described hereinafter in the particular context of applications thereof for chilling, atmospheric water harvesting (AWH) and a combination thereof.

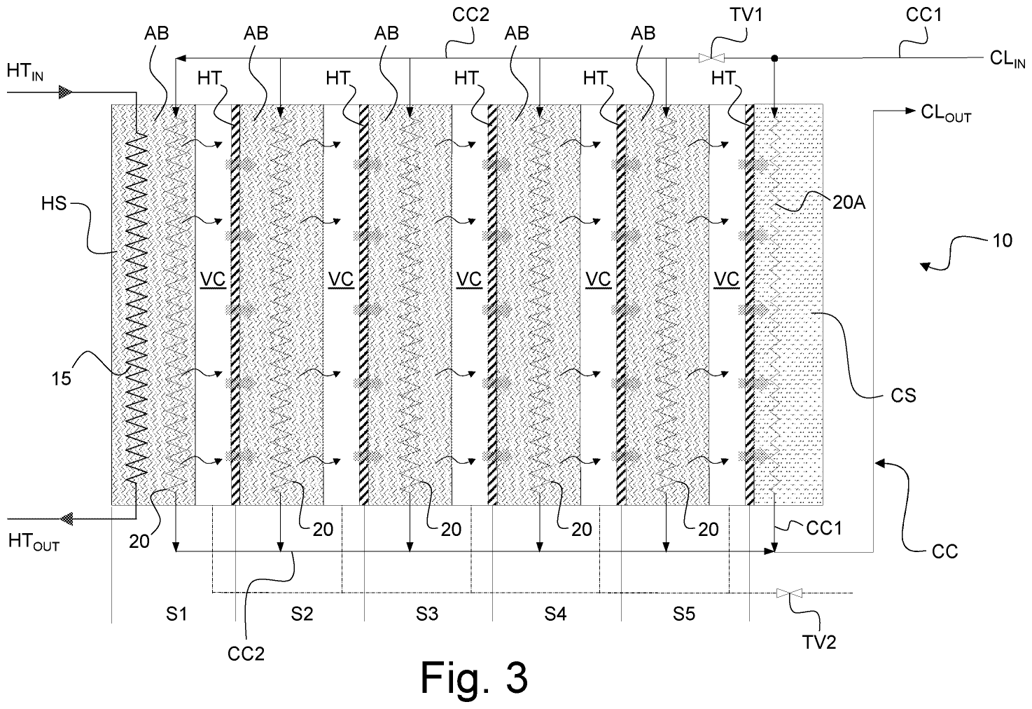

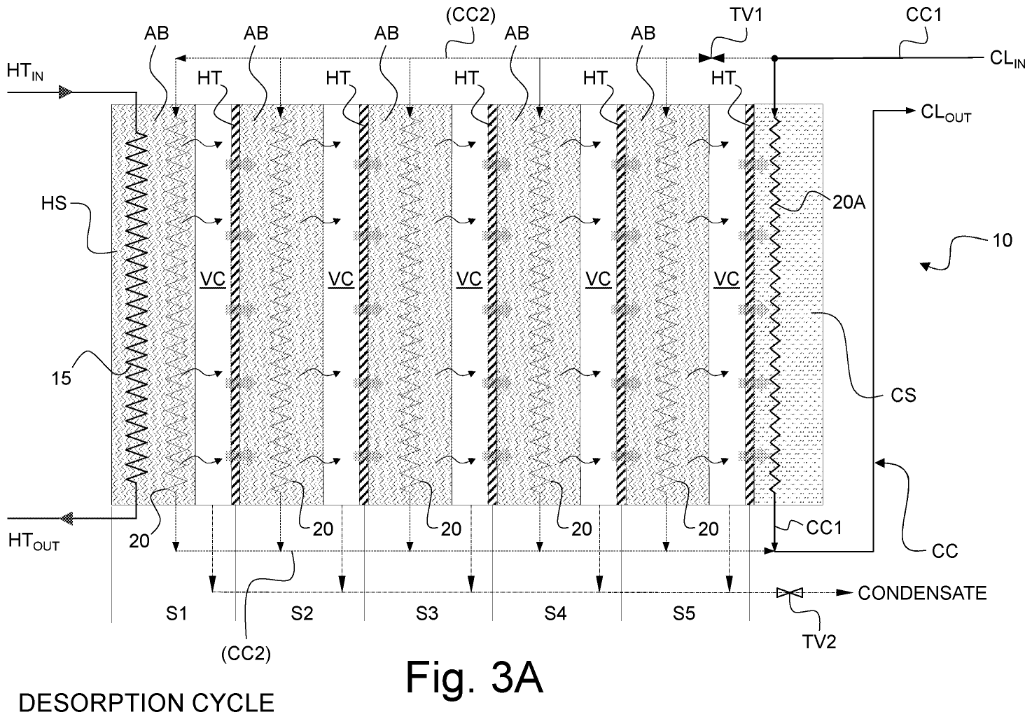

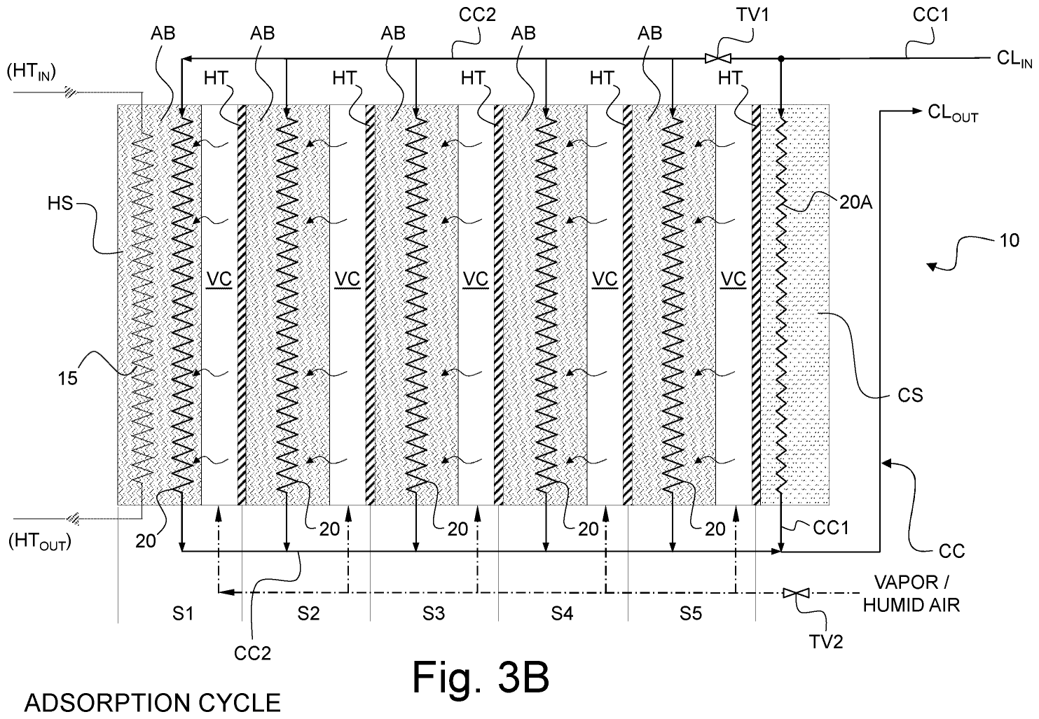

FIG. 3 is a schematic diagram of a multi-stage adsorber device, generally designated by reference numeral 10, in accordance with a preferred embodiment of the invention. Visible in FIG. 3 are a plurality of adsorption stages S1-S5 each including an adsorber AB consisting of or comprising a suitable adsorbent material, which adsorber AB is coupled to an adjacent vapor chamber VC.

The adsorbent material may be any adequate adsorbent material, including e.g. packed silica gel or zeolites. Other adsorbent materials could however be contemplated. In general, suitable adsorbent materials include silica, silica gel, zeolites, alumina gel, molecular sieves, montmorillonite clay, activated carbon, hydroscopic salts, metal-organic frameworks (MOF) such as zirconium or cobalt based adsorbents, hydrophilic polymer or cellulose fibers, and derivatives of combinations thereof.

In the illustration of FIG. 3, five adsorption stages S1-S5 (also referred to as “effects”) are shown. More specifically, the five adsorption stages S1-S5 are distributed one after the other in sequence, and the vapor chamber VC of each preceding adsorption stage S1, S2, S3, resp. S4, is coupled to the adsorber AB of a following adsorption stage S2, S3, S4, resp. S5, via a corresponding heat transfer structure HT. Furthermore, a heating stage HS is thermally coupled to the first adsorption stage S1 to selectively provide thermal energy to the adsorbers AB, while a cooling stage CS is thermally coupled to the final adsorption stage S5. In the illustrated example, one will note that a total of five heat transfer structures HT are provided at the interface between the first and second adsorption stages S1, S2, between the second and third adsorption stages S2, S3, between the third and fourth adsorption stages S3, S4, between the fourth and fifth adsorption stages S4, S5, and, lastly, between the fifth and final adsorption stage S5 and the cooling stage CS. As this will be appreciated below, each heat transfer structure HT is designed to cause desorbed vapor produced during the desorption cycle of the adsorber device 10 to condense in each vapor chamber VC along the exposed surface of the associated heat transfer structure HT, thus releasing latent heat that is transferred to the subsequent adsorber AB to sustain desorption.

In the illustrated example, the heating stage HS is in effect integrated directly into the adsorber AB of the first adsorption stage S1, namely by providing one or more heating tubes 15 extending through the adsorber AB of the first adsorption stage S1. The one or more heating tubes 15 are advantageously flowed through by a heating fluid that circulates from a heating fluid inlet HT_{IN} to a heating fluid outlet HT_{OUT}. This ensures efficient heating of the adsorber AB during the desorption phase to induce vapor desorption and release of desorbed vapor into the adjacent vapor chamber VC. Any other suitable heating stage configuration could however be contemplated to ensure supply of thermal energy to the adsorber AB of the first adsorption stage S1.

The cooling stage CS includes a suitable cooling structure that is thermally coupled to the final adsorption stage S5 to draw heat away from the adsorber device 10. More specifically, in the illustrated example the cooling stage CS includes a cooling substrate that is thermally coupled to the heat transfer structure HT of the final adsorption stage S5. In other embodiments, the heat transfer structure HT of the final adsorption stage S5 could be an integral part of the cooling stage CS. The cooling stage CS is coupled to a first cooling section CC1 of a cooling circuit CC to cause circulation of a cooling fluid through the cooling stage CS. In the illustrated example, the cooling stage CS includes one or more heat exchanger tubes 20A coupled to the first cooling section CC1.

According to the invention, the cooling circuit CC further includes a second cooling section CC2 that is designed to allow selective circulation of the cooling fluid through each of the adsorbers AB. In the illustrated example, and in a manner similar to the cooling stage CS, each adsorber AB likewise includes one or more heat exchanger tubes 20 configured to allow circulation of the cooling fluid therethrough, which heat exchanger tubes 20 are coupled to the second cooling section CC2.

Cooling fluid (such as water) circulates through the cooling circuit CC from a cooling fluid inlet CL_{IN} to a cooling fluid outlet CL_{OUT}. More specifically, according to the invention, the cooling circuit CC is configured to selectively cause circulation of the cooling fluid only through the first cooling section CC1 (and therefore only through the cooling stage CS) during the desorption cycle of the adsorber device 10 and through both the first and second cooling sections CC1, CC2 (and therefore through the cooling stage CS and each adsorber AB) during the adsorption cycle of the adsorber device 10.

The aforementioned heat exchanger tubes 20A, 20 are preferably comprised of thin-walled fin tubes (i.e. tubes provided with fins extending on the external walls of the tubes) or plates-tubes (i.e. tubes integrated to plate structures) to improve thermal transfer efficiency. This in particular allows to increase the amount of adsorbent material in the adsorbers AB with good thermal contact with the heat exchanger tubes 20 for a given volume.

While the first and second cooling sections CC1, CC2 could be fed independently one from the other, the first and second cooling sections CC1, CC2 are preferably coupled to one another via a throttle valve TV1, which throttle valve TV1 is closed during the desorption cycle to cause cooling fluid to circulate exclusively through the first cooling section CC1 and opened during the adsorption cycle to cause cooling fluid to circulate both through the first and second cooling sections CC1, CC2.

Also visible in FIG. 3 is another throttle valve TV2 that is used to selectively couple the adsorption stages S1-S5 to an external adsorbate source during the adsorption cycle, such as an evaporator feeding vapor or an ambient air intake feeding humid air. During the desorption cycle, throttle valve TV2 is used to allow collection of condensate forming in the vapor chambers VC.

FIG. 3A is a schematic diagram of the multi-stage adsorber device 10 of FIG. 3 depicting operation thereof during the desorption cycle. As already mentioned, throttle valve TV1 is closed during desorption, whereas throttle valve TV2 is activated to allow collection of condensate forming in the adsorption stages S1-S5. Accordingly, cooling fluid is supplied exclusively to the cooling stage CS. The heating stage HS is activated thus supplying thermal energy to the adsorber AB of the first adsorbent stage S1, inducing vapor desorption resulting in desorbed vapor flowing from the adsorber AB into the adjacent vapor chamber VC. Desorbed vapor condenses along a surface of the heat transfer structure HT of the first adsorption stage S1, releasing latent heat as a result which is transferred to the adsorber AB of the second desorption stage S2 to sustain desorption. Latent heat is thus recovered to re-heat the adsorbent material located in the following adsorber AB, thereby improving energy usage efficiency. Condensate formed as a result of condensation in the vapor chambers VC during the desorption cycle is collected and returned, via throttle valve TV2, to a suitable coolant reservoir or collection tank (not shown in FIG. 3A).

Preferably, heating fluid is supplied to the heating stage HS at a temperature comprised between 90° C. and 95° C., while the cooling fluid is supplied at a temperature comprised between 50° C. and 60° C.

FIG. 3B is a schematic diagram of the multi-stage adsorber device 10 of FIG. 3 depicting operation thereof during the adsorption cycle. The heating stage HS is deactivated during the adsorption cycle, thus ceasing all supply of thermal energy. As already mentioned, throttle valve TV1 is opened during adsorption, while throttle valve TV2 is used to couple the adsorption stages S1-S5 to an external adsorbate source. Accordingly, cooling fluid is supplied both to the cooling stage CS and each of the adsorbers AB, thus achieving rapid cooling of the adsorbents down after the desorption cycle to the desirable adsorption temperature for enhanced adsorption. Cooling of the adsorbers AB further allows to remove adsorption heat and maintain a constant adsorbent temperature throughout the adsorption cycle to ensure optimal adsorption efficiency.

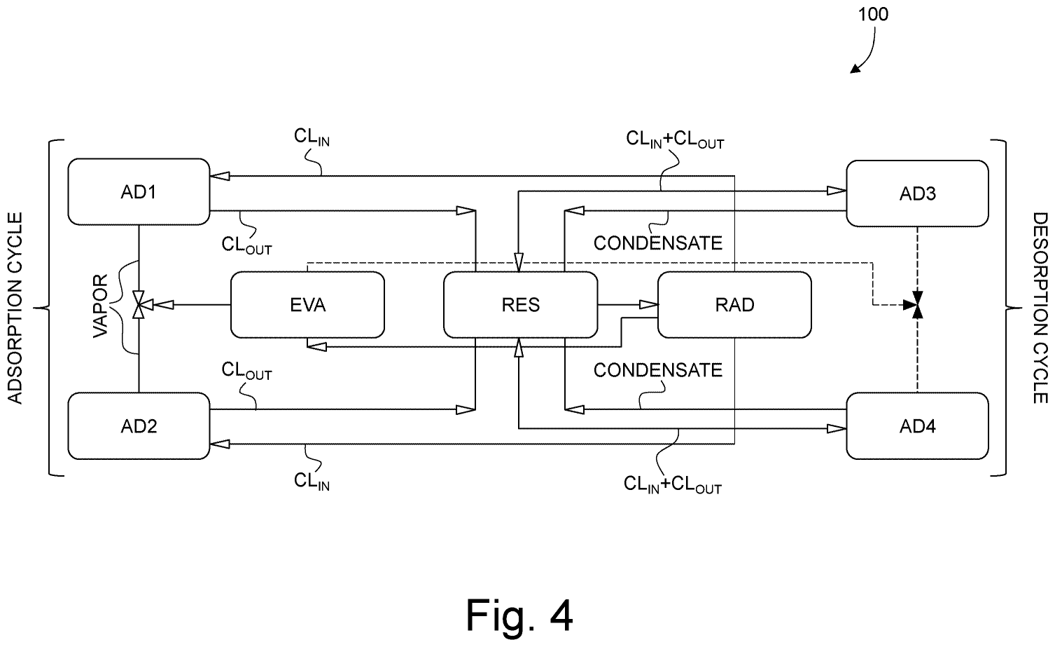

The multi-stage adsorber device of the invention may especially be used for chilling or for atmospheric water harvesting (AWH). Specific examples will be discussed with references to FIGS. 4 to 8. When operating the adsorber device as chiller device, vapor produced by a dedicated evaporator is fed to the adsorption stages S1-S5 during the adsorption cycle, via the throttle valve TV2, and flows into the adsorbers AB to adsorb water molecules. When operating the adsorber device 10 as atmospheric water harvesting (AWH) device, humid air fed by a dedicated ambient air intake is supplied to the adsorption stages S1-S5 during the adsorption cycle, via the throttle valve TV2, leading to adsorption of water molecules contained in the humid air intake.

The multi-stage adsorber device of the invention may comprise any suitable number of adsorption stages. From a practical perspective, the integer number n of adsorption stages that may be contemplated advantageously ranges from 2 to 15. The actual number of adsorption stages used in practice will be selected depending on, especially, the type of adsorbent material being used as adsorber and the performance characteristics thereof.

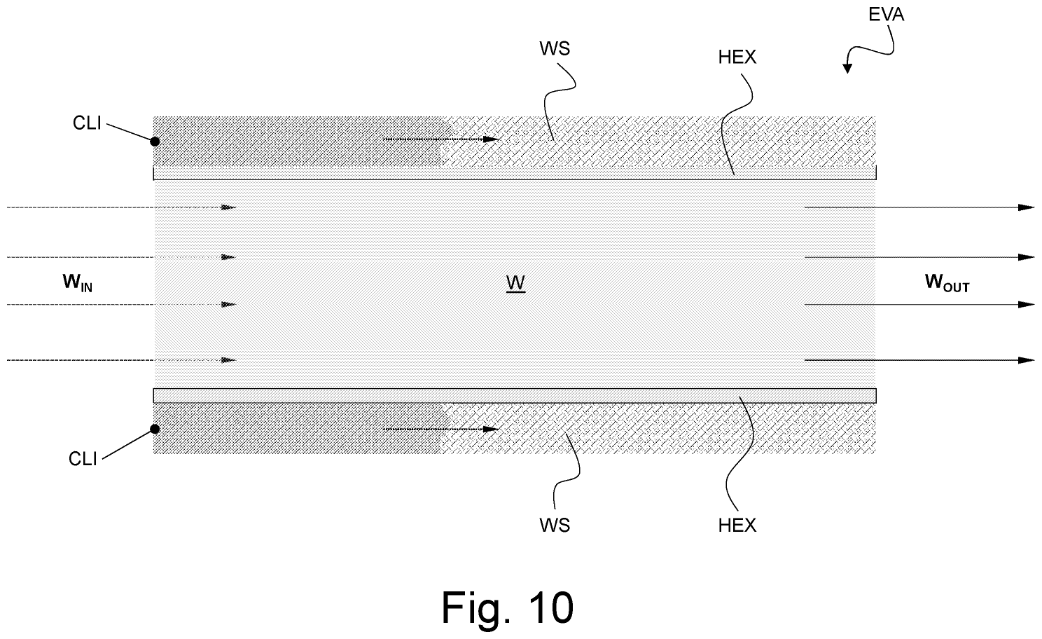

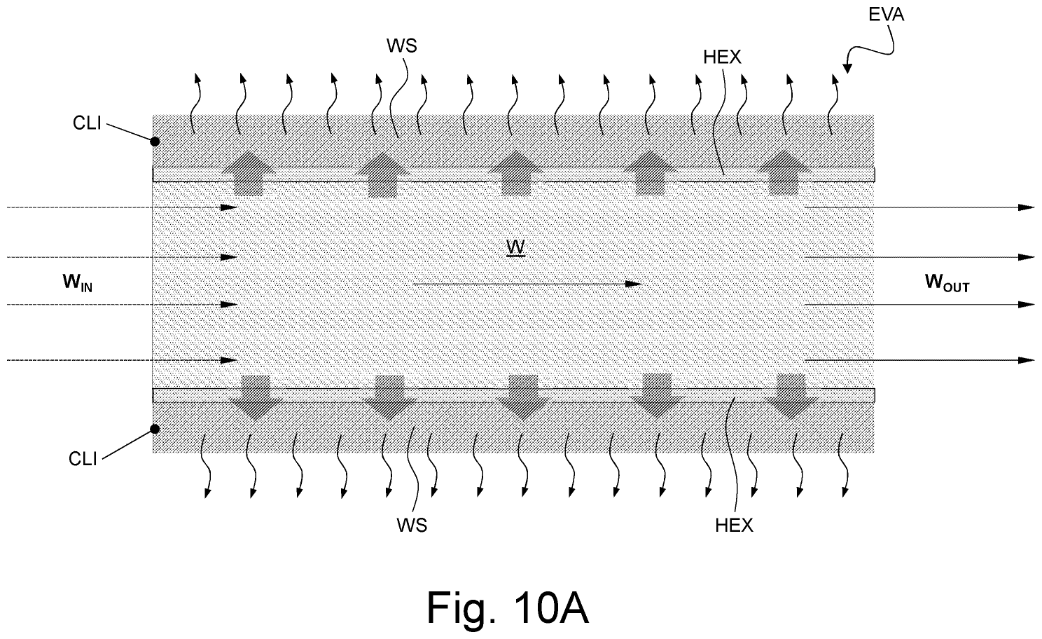

From a general perspective, a suitable chiller apparatus according to the invention essentially comprises at least one multi-stage adsorber device as discussed above acting as chiller device, a coolant reservoir to supply cooling fluid to the multi-stage adsorber device, and an evaporator to supply vapor to the adsorption stages of the multi-stage adsorber device during the adsorption cycle of the multi-stage adsorber device. The evaporator may be any suitable evaporator capable of inducing evaporation of the cooling fluid. Preferably, the evaporator is based on a particularly advantageous evaporator configuration as discussed in greater detail herein with reference to FIGS. 10 to 12.

From a general perspective, a suitable atmospheric water harvesting (AWH) apparatus according to the invention essentially comprises at least one multi-stage adsorber device as discussed above acting as atmospheric water harvesting device, a coolant reservoir to supply cooling fluid to the multi-stage adsorber device, and an ambient air intake to feed humid air to the adsorption stages during the adsorption cycle of the multi-stage adsorber device.

FIG. 4 is a schematic diagram of an illustrative example of a quad-adsorber bed chiller system 100 in accordance with an embodiment of the invention. The chiller system 100 includes two interconnected pairs of multi-stage adsorber devices AD1 to AD4, namely a first interconnected pair AD1, AD2 forming a first chiller module AD1/AD2 and a second interconnect pair AD3, AD4 forming a second chiller module AD3/AD4. A coolant reservoir RES is provided to supply cooling fluid to the first and second chiller modules AD1/AD2, AD3/AD4. A suitable evaporator EVA used e.g. for space cooling is further provided to selectively supply vapor to the first chiller module AD1/AD2 or to the second chiller module AD3/AD4. In the illustrated example, a radiator RAD is further provided, which radiator RAD is coupled to the coolant reservoir RES and the evaporator EVA for re-cooling of warm cooling fluid coming from the coolant reservoir RES. Supply of cooling fluid from the coolant reservoir RES is ensured by a suitable pump.

The chiller system 100 of FIG. 4 is configured such that, when the first chiller module AD1/AD2 undergoes the adsorption cycle, the second chiller module AD3/AD4 undergoes the desorption cycle, and vice versa. Cooling fluid is supplied from the coolant reservoir RES through the radiator RAD to the first chiller module AD1/AD2 or the second chiller module AD3/AD4 depending on whether the first chiller module AD1/AD2 or the second chiller module AD3/AD4 undergoes the adsorption cycle to feed the cooling stage and adsorbers of each relevant adsorber device. Conversely, cooling fluid is supplied from the coolant reservoir RES, directly, to the first chiller module AD1/AD2 or the second chiller module AD3/AD4 depending on whether the first chiller module AD1/AD2 or the second chiller module AD3/AD4 undergoes the desorption cycle to feed exclusively the cooling stage of each relevant adsorber device.

Vapor is supplied from the evaporator EVA to the first chiller module AD1/AD2 or the second chiller module AD3/AD4 depending on whether the first chiller module AD1/AD2 or the second chiller module AD3/AD4 undergoes the adsorption cycle.

Condensate formed as a result of condensation in the first chiller module AD1/AD2 or the second chiller module AD3/AD4, when undergoing the desorption cycle, is returned to the coolant reservoir RES.

For the sake of illustration, FIG. 4 shows the first chiller module AD1/AD2 undergoing the adsorption cycle, while the second chiller module AD3/AD4 is undergoing the desorption cycle. It will be appreciated and understood that operation of the first and second chiller modules AD1/AD2, AD3/AD4 is cycled and alternated between the adsorption and desorption cycles.

Not shown in FIG. 4 is a suitable thermal energy source to supply the first chiller module AD1/AD2 or the second chiller module AD3/AD4 with thermal energy depending on whether the first chiller module AD1/AD2 or the second chiller module AD3/AD4 undergoes the desorption cycle.

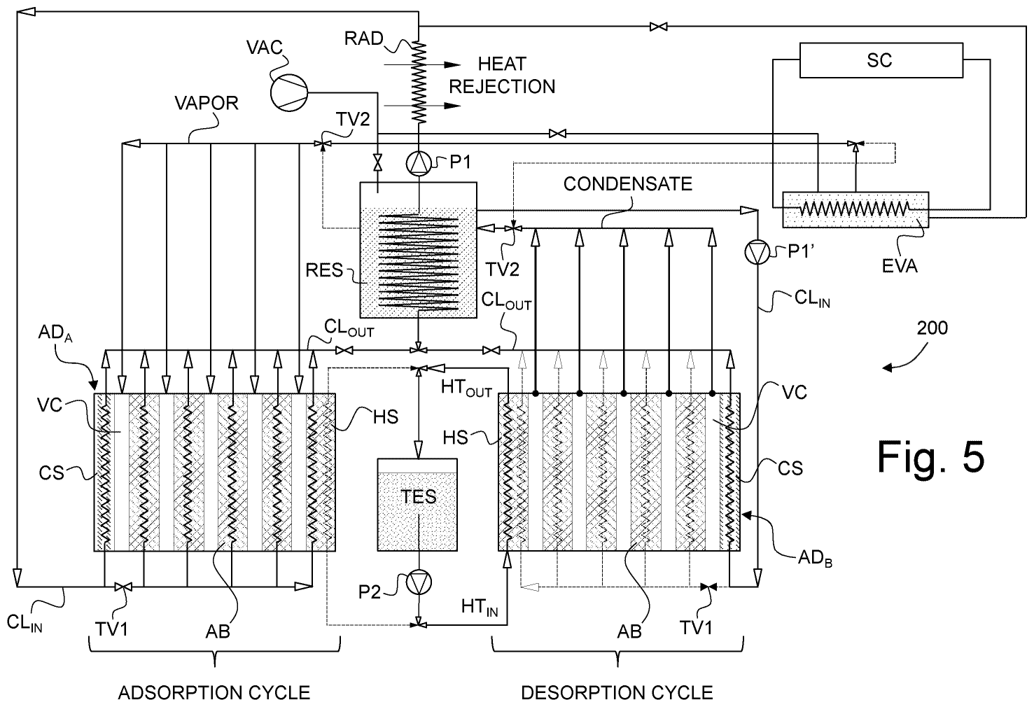

FIG. 5 is a schematic diagram of an illustrative example of a dual-adsorber bed chiller system 200 in accordance with another embodiment of the invention. The chiller system 200 includes two adsorber devices, namely a first adsorber device AD_{A} forming a first chiller module and a second adsorber device AD_{B} forming a second chiller module. A coolant reservoir RES is again provided to supply cooling fluid to the first and second chiller modules AD_{A}, AD_{B}. A suitable evaporator EVA used for space cooling SC is likewise further provided to selectively supply vapor to the first chiller module AD_{A} or to the second chiller module AD_{B}. In the illustrated example, a radiator RAD is once again further provided, which radiator RAD is coupled to the coolant reservoir RES and the evaporator EVA for re-cooling of warm cooling fluid coming from the coolant reservoir RES. Supply of cooling fluid from the coolant reservoir RES is ensured by one or more suitable pumps P1, P1′.

Also shown in FIG. 5 is a suitable thermal energy source TES to supply the first chiller module AD_{A} or the second chiller module AD_{B}, namely the heating stage HS thereof, with thermal energy depending on whether the first chiller module AD_{A} or the second chiller module AD_{B} undergoes the desorption cycle. Supply of heating fluid from the thermal energy source TES to the heating stage HS of the relative chiller module AD_{A} or AD_{B} is ensured by a suitable pump P2.

The thermal energy source TES may ideally originate from a renewable energy source, such as solar thermal energy, or industrial waste heat processes. More specifically, the thermal energy source TES could include any suitable storage device capable of storing thermal energy, such as a device comprising a material capable of undergoing a phase change (or so-called “Phase-Change Material”/PCM) and performing so-called “Latent Heat Storage” (LHS). A multitude of PCMs are available, including e.g. salts, polymers, gels, paraffin waxes and metal alloys. Other suitable solutions may rely on materials capable of performing so-called “Sensible Heat Storage” (SHS), such as molten salts or metals. “Thermo-chemical Heat Storage” (TCS) constitutes yet another possible solution to perform thermal energy storage.

The chiller system 200 of FIG. 5 is configured such that, when the first chiller module AD_{A} undergoes the adsorption cycle, the second chiller module AD_{B} undergoes the desorption cycle, and vice versa. Cooling fluid is supplied from the coolant reservoir RES through the radiator RAD to the first chiller module AD_{A} or the second chiller module AD_{B} depending on whether the first chiller module AD_{A} or the second chiller module AD_{B} undergoes the adsorption cycle to feed the cooling stage CS and adsorbers AB of each relevant adsorber device. Conversely, cooling fluid is supplied from the coolant reservoir RES, directly, to the first chiller module AD_{A} or the second chiller module AD_{B} depending on whether the first chiller module AD_{A} or the second chiller module AD_{B} undergoes the desorption cycle to feed exclusively the relevant cooling stage CS.

Vapor is supplied from the evaporator EVA to the first chiller module AD_{A} or the second chiller module AD_{B} depending on whether the first chiller module AD_{A} or the second chiller module AD_{B} undergoes the adsorption cycle.

Condensate formed as a result of condensation in the first chiller module AD_{A} or the second chiller module AD_{B}, when undergoing the desorption cycle, is returned to the coolant reservoir RES.

For the sake of illustration, FIG. 5 shows the first chiller module AD_{A} undergoing the adsorption cycle, the associated throttle valve TV1 being opened to ensure that the cooling stage CS and adsorbers AB thereof are appropriately cooled, while vapor is being supplied from the evaporator EVA via the associated throttle valve TV2 to the first chiller module AD_{A}. Conversely, the second chiller module AD_{B} is undergoing the desorption cycle, the associated throttle valve TV1 being closed to ensure that exclusively the cooling stage CS is cooled in this case. Thermal energy is here supplied to the heating stage HS of the second chiller module AD_{B} to sustain desorption, and the resulting condensate is fed back to the coolant reservoir RES.

It will once again be appreciated and understood that operation of the first and second chiller modules AD_{A}, AD_{B} is cycled and alternated between the adsorption and desorption cycles.

Also shown in FIG. 5 is a low-pressure system to maintain the first chiller module AD_{A} and the second chiller module AD_{B} in a partial vacuum condition during adsorption and desorption. More specifically, in the illustrated example, a vacuum pump VAC can selectively be coupled to the coolant reservoir RES and to the evaporator EVA during a start-up phase with a view to remove air from the system and bring pressure in the entire adsorption chiller system 200 down to partial vacuum pressure (e.g. 1 kPa or less). Once partial vacuum is achieved, valves connecting the vacuum pump VAC to the coolant reservoir RES and to the evaporator EVA may be closed and the vacuum pump VAC may be switched off. Ideally, system pressure is maintained within a range of 1 to 8 kPa (or less) during adsorption and desorption.

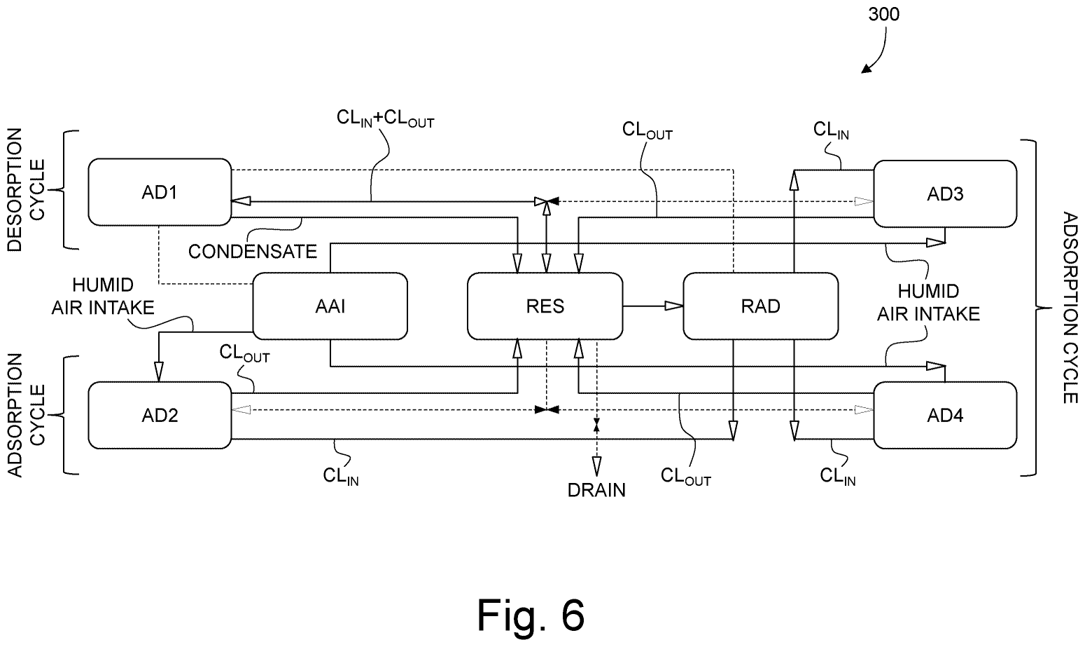

FIG. 6 is a schematic diagram of an illustrative example of a quad-adsorber bed atmospheric water harvesting (AWH) system 300 in accordance with an embodiment of the invention. The AWH system 300 includes a total of four multi-stage adsorber devices AD1 to AD4 each acting as an AWH device. A coolant reservoir RES is provided to supply cooling fluid to each AWH device AD1-AD4. A suitable ambient air intake AAI used to extract humid air from the ambient atmosphere is further provided to selectively feed humid air to the AWH devices. In the illustrated example, a radiator RAD is further provided, which radiator RAD is coupled to the coolant reservoir RES for re-cooling of warm cooling fluid coming from the coolant reservoir RES.

The AWH system 300 of FIG. 6 is configured such that only one AWH device AD1, AD2, AD3 or AD4 undergoes the desorption cycle at any given time, while all remaining multi-stage adsorber devices undergo the adsorption cycle. Cooling fluid is supplied from the coolant reservoir RES through the radiator RAD to each AWH device undergoing the adsorption cycle to feed the cooling stage and adsorbers of each relevant AWH device. Conversely, cooling fluid is supplied from the coolant reservoir RES, directly, to the AWH device undergoing the desorption cycle to feed exclusively the cooling stage thereof.

Humid air is fed from the ambient air intake AAI to all AWH devices undergoing the adsorption cycle.

Condensate formed as a result of condensation in the AWH device undergoing the desorption cycle, is returned to the coolant reservoir RES. As schematically shown in FIG. 6, the coolant reservoir RES may be provided with a drainage port to selectively drain condensate from the coolant reservoir RES when full.

For the sake of illustration, FIG. 6 shows the first AWH device AD1 undergoing the desorption cycle, while the remaining AWH devices AD2, AD3, AD4 are undergoing the adsorption cycle. It will be appreciated and understood that operation of the first to fourth AWH devices AD1-AD4 is cycled between the adsorption and desorption cycles.

Not shown in FIG. 6 is a suitable thermal energy source to supply each AWH device with thermal energy depending on whether the relevant AWH device undergoes the desorption cycle.

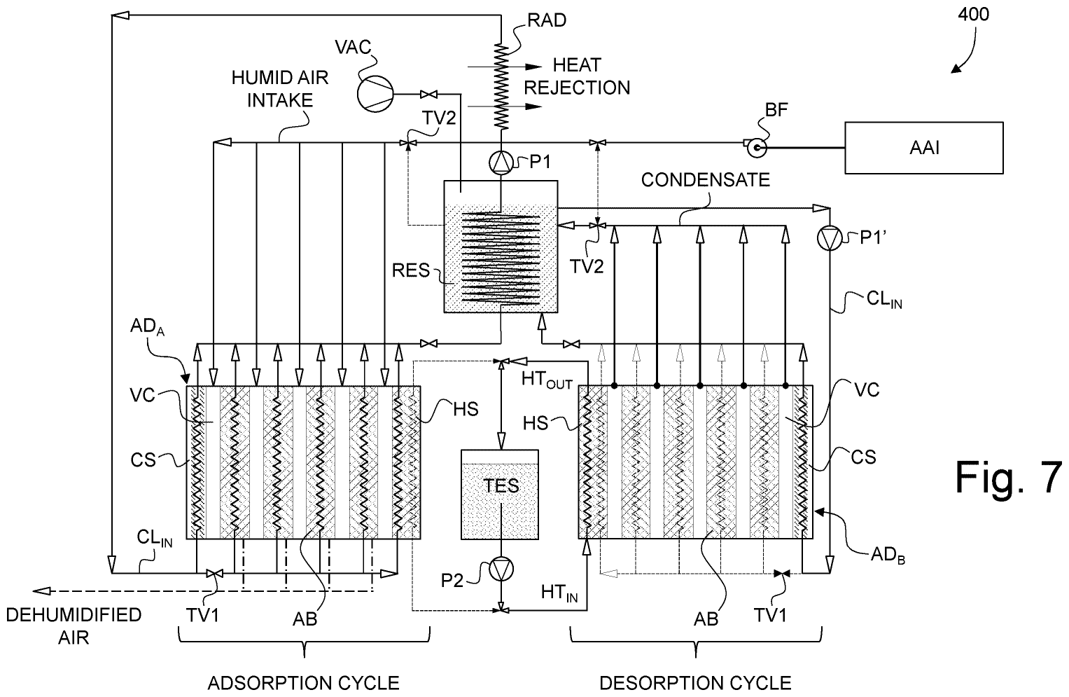

FIG. 7 is a schematic diagram of an illustrative example of a dual-adsorber bed AWH system 400 in accordance with another embodiment of the invention. The AWH system 400 includes two adsorber devices, namely a first adsorber device AD_{A} acting as first AWH device and a second adsorber device AD_{B} acting as second AWH device. A coolant reservoir RES is again provided to supply cooling fluid to the first and second AWH devices AD_{A}, AD_{B}. A suitable ambient air intake AAI is likewise further provided to selectively feed humid air to the first AWH device AD_{A} or to the second AWH device AD_{B}. In the illustrated example, a radiator RAD is once again further provided, which radiator RAD is coupled to the coolant reservoir RES for re-cooling of warm cooling fluid coming from the coolant reservoir RES. Supply of cooling fluid from the coolant reservoir RES is once again ensured by one or more suitable pumps P1, P1′.

As shown in FIG. 7, the ambient air intake AAI is coupled to a blower fan BF to force circulation of humid air through the adsorbers AB of the relevant multi-stage adsorber device AD_{A} or AD_{B} undergoing the adsorption cycle.

Also shown in FIG. 7 is a suitable thermal energy source TES to supply the first AWH device AD_{A} or the second AWH device AD_{B}, namely the heating stage HS thereof, with thermal energy depending on whether the first AWH device AD_{A} or the second AWH device AD_{B} undergoes the desorption cycle. Supply of heating fluid from the thermal energy source TES to the heating stage HS of the relative AWH device AD_{A} or AD_{B} is once again ensured by a suitable pump P2.

The AWH system 400 of FIG. 7 is configured such that, when the first AWH device AD_{A} undergoes the adsorption cycle, the second AWH device AD_{B} undergoes the desorption cycle, and vice versa. Cooling fluid is supplied from the coolant reservoir RES through the radiator RAD to the first AWH device AD_{A} or the second AWH device AD_{B} depending on whether the first AWH device AD_{A} or the second AWH device AD_{B} undergoes the adsorption cycle to feed the cooling stage CS and adsorbers AB of the relevant AWH device. Conversely, cooling fluid is supplied from the coolant reservoir RES, directly, to the first AWH device AD_{A} or the second AWH device AD_{B} depending on whether the first AWH device AD_{A} or the second AWH device AD_{B} undergoes the desorption cycle to feed exclusively the relevant cooling stage CS.

Humid air is fed from the ambient air intake AAI to the first AWH device AD_{A} or the second AWH device AD_{B} depending on whether the first AWH device AD_{A} or the second AWH device AD_{B} undergoes the adsorption cycle.

Condensate formed as a result of condensation in the first AWH device AD_{A} or the second AWH device AD_{B}, when undergoing the desorption cycle, is returned to the coolant reservoir RES.

For the sake of illustration, FIG. 7 shows the first AWH device AD_{A} undergoing the adsorption cycle, the associated throttle valve TV1 being opened to ensure that the cooling stage CS and adsorbers AB thereof are appropriately cooled, while humid air is being fed from the ambient air intake AAI via the associated throttle valve TV2 to the first AWH device AD_{A}. Conversely, the second AWH device AD_{B} is undergoing the desorption cycle, the associated throttle valve TV1 being closed to ensure that exclusively the cooling stage CS is cooled in this case. Thermal energy is here supplied to the heating stage HS of the second AWH device AD_{B} to sustain desorption, and the resulting condensate is fed back to the coolant reservoir RES.

It will once again be appreciated and understood that operation of the first and second AWH devices AD_{A}, AD_{B} is cycled and alternated between the adsorption and desorption cycles.

Also shown in FIG. 7 is a low-pressure system to maintain the first AWH device AD_{A} or the second AWH device AD_{B} in a partial vacuum condition during desorption. More specifically, in the illustrated example, a vacuum pump VAC can selectively be coupled to the coolant reservoir RES with a view to maintain partial vacuum pressure in the relevant AWH device undergoing desorption, thereby improving desorption efficiency as water retention in adsorber pores decreases with pressure, hence water will desorb more easily from the adsorbers AB. By contrast, adsorption will take place under ambient pressure.

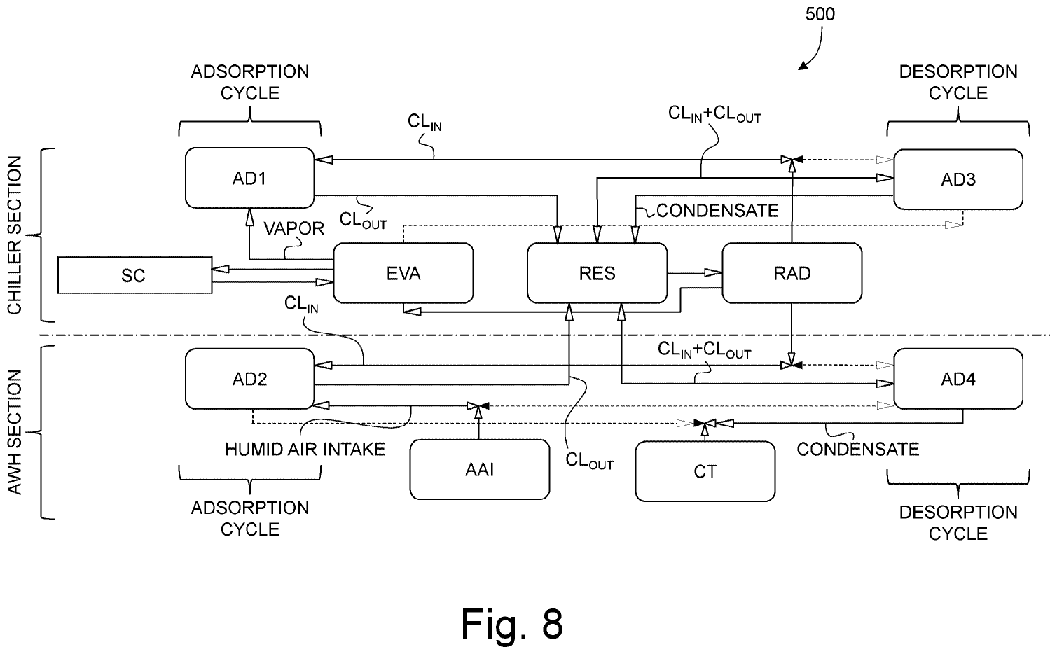

FIG. 8 is a schematic diagram of an illustrative example of a quad-adsorber bed hybrid system 500 for combined chilling and atmospheric water harvesting (AWH) in accordance with an embodiment of the invention. The hybrid system 500 includes a total of four multi-stage adsorber devices AD1 to AD4, namely a first pair of adsorber devices AD1, AD3 acting as chiller devices and a second pair of adsorber devices AD2, AD4 acting as AWH devices. A coolant reservoir RES is provided to supply cooling fluid to each adsorber device AD1-AD4. A suitable evaporator EVA used for space cooling SC is provided to selectively supply vapor to one or the other chiller device AD1 or AD3. A suitable ambient air intake AAI used to extract humid air from the ambient atmosphere is further provided to selectively feed humid air to one or the other AWH device AD2 or AD4. In the illustrated example, a radiator RAD is further provided, which radiator RAD is coupled to the coolant reservoir RES and evaporator EVA for re-cooling of warm cooling fluid coming from the coolant reservoir RES. Furthermore, a separate condensate tank CT is provided to collect condensate produced by each AWH device AD2, AD4 during desorption.

The hybrid system 500 of FIG. 8 is configured such that when one of the chiller devices AD1, AD3 undergoes the adsorption cycle, the other chiller device undergoes the adsorption cycle, and such that when one of the AWH devices AD2, AD4 undergoes the adsorption cycle, the other AWH device undergoes the adsorption cycle. Cooling fluid is supplied from the coolant reservoir RES through the radiator RAD to each adsorber device undergoing the adsorption cycle to feed the cooling stage and adsorbers of each relevant adsorber device. Conversely, cooling fluid is supplied from the coolant reservoir RES, directly, to the adsorber device undergoing the desorption cycle to feed exclusively the cooling stage thereof.

Vapor is supplied from the evaporator EVA to the relevant chiller device AD1 or AD3 undergoing the adsorption cycle, while humid air is fed from the ambient air intake AAI to the relevant AWH device AD2 or AD4 undergoing the adsorption cycle.

Condensate formed as a result of condensation in the chiller device AD1 or AD3 undergoing the desorption cycle is returned to the coolant reservoir RES, while condensate formed as a result of condensation in the AWH device AD2 or AD4 undergoing the desorption cycle is collected in the condensate tank CT.

For the sake of illustration, FIG. 8 shows the chiller device AD1 and AWH device AD2 undergoing the adsorption cycle, while the other chiller device AD3 and AWH device AD4 are undergoing the desorption cycle. It will be appreciated and understood that operation of the chiller devices AD1, AD3 and AWH devices AD2, AD4 is cycled between the adsorption and desorption cycles.

Not shown in FIG. 6 is a suitable thermal energy source to supply each chiller device AD1, AD3 and AWH device AD2, AD4 with thermal energy depending on whether the relevant adsorber device undergoes the desorption cycle.

In a manner similar to the system depicted in FIG. 5, a low-pressure system may be provided to maintain each chiller device AD1, AD3 in a partial vacuum condition during adsorption and desorption (the comments made hereinabove with reference to the low-pressure system of FIG. 5 being directly transposable to the chiller section shown in FIG. 8). Likewise, in a manner similar to the system depicted in FIG. 7, a low-pressure system may be provided to maintain the AWH device AD2, AD4 undergoing the desorption cycle in a partial vacuum condition (the comments made hereinabove with reference to the low-pressure system of FIG. 7 being directly transposable to the AWH section shown in FIG. 8).

In more general terms, the invention provides for a method of carrying out multi-stage adsorption, especially for the purpose of chilling or atmospheric water harvesting (AWH), the method comprising the following steps:
(a) providing at least one multi-stage adsorption module designed to operate in alternate desorption and adsorption cycles, the multi-stage adsorption module including two or more successive adsorption stages each comprising an adsorber coupled to an adjacent vapor chamber, wherein the adsorber of each following adsorption stage is thermally coupled to the vapor chamber of a preceding adsorption stage via a heat transfer structure;
(b) operating the multi-stage adsorption module in the desorption cycle by supplying thermal energy to the adsorber of at least a first one of the adsorption stages to induce vapor desorption and taking thermal energy away from the adsorber of a final one of the adsorption stages to cause condensation of desorbed vapor, whereby desorbed vapor is released by each adsorber and flows to each adjacent vapor chamber where it condenses along a surface of each heat transfer structure, thereby releasing latent heat that is transferred to the adsorber of each following adsorption stage to sustain vapor desorption; and
(c) operating the multi-stage adsorption module in the adsorption cycle by ceasing all supply of thermal energy to the adsorber of the first one of the adsorption stages and taking thermal energy away from the adsorbers of all adsorption stages to cool the adsorbers and sustain adsorption.

With regard to the performance of the adsorber device of the invention as chiller device, it will be appreciated that refrigerant evaporation plays an important part. With current evaporator designs, heat transfer bottleneck is mainly attributed to inefficient heat transfer from the cold side of the evaporator.

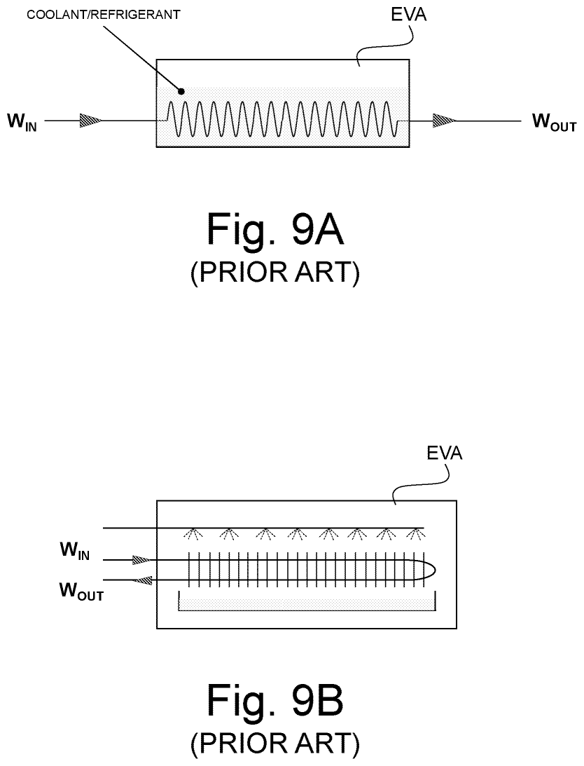

FIG. 9A is a schematic diagram illustrating the known principle of an immersed evaporator where heat is transferred into the coolant/refrigerant via immersion of the relevant heat exchanger structure directly in the coolant/refrigerant. Efficient cooling requires optimum liquid contact of the entire immersed heat exchanger area. Main disadvantages of this solution reside in (i) the huge liquid pool volume required to fully submerge the heat exchanger area, yielding a high thermal inertia, (ii) insufficient heat transfer area for evaporation as evaporation conventionally occurs at the liquid pool volume liquid-vapor interface, and (iii) low heat transfer coefficient between heat exchanger and refrigerant.

FIG. 9B is a schematic diagram illustrating the know principle of a spray evaporator where coolant is sprayed via nozzles onto the external surface of the heat exchanger. This other solution has the advantage of achieving higher heat transfer coefficient compared to immersed evaporators due to spraying inducing thin film evaporation. The minimal liquid film thickness yields minimal thermal resistance, which enhances in turn evaporative heat transfer. Implementation of this solution however induces high pressure drop across the spray nozzles, hence requires assistance of a pump, and therefore higher electricity consumption. Furthermore, coolant usage remains suboptimal in that a certain amount of coolant is not evaporated, which requires collection of the unevaporated coolant and recirculation, typically requiring a dedicated pump.

FIGS. 10 and 10A are schematic illustrations explaining the underlying principle of an evaporator EVA in accordance with a particularly preferred embodiment of the invention. This evaporator EVA can suitably be used in combination with the aforementioned multi-stage adsorber device when used for chilling applications, such as in the context of the embodiments discussed with reference to FIGS. 4, 5 and 8. In essence, this evaporator EVA relies on the use of (i) a suitable heat exchanger structure HEX configured to allow transfer of heat from a heat source, such as a warm fluid W used e.g. for space cooling, (ii) a porous wick structure WS that is thermally coupled to the heat exchanger structure HEX and is configured to be wettable by a suitable liquid cooling medium, such as water, and (iii) a coolant dispensing system configured to wet the porous wick structure WS by means of the liquid cooling medium. FIG. 10 shows the porous wick structure WS in the process of being wetted by the liquid cooling medium, which is supplied by the coolant dispensing system at a coolant inlet CLI. Wetting of the porous wick structure WS is preferably carried out by capillary action by supplying the liquid cooling medium at one or more appropriate coolant inlets that are chosen to ensure that the porous wick structure WS can be fully and optimally wetted and remains in a wetted state for as long as evaporation is required, as illustrated schematically by FIG. 10A. Supply of the liquid cooling medium may be ensured by the provision of a suitable pump or micro-pump sufficient to ensure continuous (or semi-continuous) supply of liquid cooling medium to the porous wick structure WS. Referring to e.g. the chiller system 200 of FIG. 5, a suitable amount of coolant fluid can be taken from the coolant reservoir RES and fed by the pump P1, via the radiator RAD, to the porous wick structure WS of the evaporator EVA to induce cooling by evaporation. The by-product of such evaporation, i.e. cooling fluid vapor, can then be supplied to the relevant multi-stage adsorber device(s) undergoing adsorption as previously explained.

By way of preference, the heat exchanger structure HEX is structured to include a plurality of channels (only one being shown for the purpose of explanation in FIGS. 10 and 10A) to channel the warm fluid W acting as the heat source. In FIGS. 10 and 10A, the warm fluid W is schematically shown as flowing from the left to the right from a warm liquid inlet W_{IN} to a cold liquid outlet W_{OUT}.

The porous wick structure WS may be provided either directly or indirectly on the heat exchanger structure HEX via possibly one or more thermally conductive intermediate layers or coatings. Any suitable thermally conductive layer(s) or coating(s), if provided, could come into consideration, including but not limited to fine diamond coatings, copper matrix composites with diamond reinforced particles such as Cu—Zr/diamond composites, titanium coated diamond particles, and thermal adhesives comprising metallic compounds such as indium, metal oxides, and silica compounds. In all cases, good thermal conductivity between the heat exchanger structure HEX and the porous wick structure WS should be ensured for maximum cooling efficiency, as the porous wick structure WS is meant to play an essential role in the extraction of heat and evaporator efficiency. More specifically, the porous wick structure WS is designed to induce cooling by evaporation, as explained in greater detail hereafter.

The porous wick structure may be formed by any adequate technique. Sintering especially comes into consideration as porosity of the resulting sintered structure can reasonably be controlled to remain within desired tolerances. In that regard, and irrespective of the actual technique used to produce the porous wick structure WS, porosity thereof should ideally be comprised between approximately 20% and 80%. In accordance with a preferred embodiment of the invention, the porous wick structure advantageously exhibits pores having an average size comprised between approximately 5 μm and 50 μm.

Thickness of the porous wick structure WS will be selected in accordance with the particular evaporator configuration and requirements. By way of preference, such thickness can be comprised between approximately 0.5 mm and up to 5 mm, which is normally sufficient to ensure adequate wetting of the structure and optimal cooling efficiency. Other dimensions could however be contemplated depending on the cooling power loading and geometrical constraints of the relevant evaporator.

The aforementioned considerations regarding the configuration of and the relevant techniques used to produce and form the porous wick structure WS are applicable to all embodiments disclosed herein.

When in operation, thermal energy from the incoming warm fluid W flowing through the heat exchanger structure HEX is transferred to the wetted porous wick structure WS. Under the action of vapor flow interacting with the exposed portions of the wetted porous wick structure, evaporative cooling is induced at the interface between the vapor space within the evaporation chamber and the wetted porous wick structure WS, in a process that can be referred to as thin film evaporation. As a result, heat is taken away from the system and the liquid cooling medium used to wet the porous wick structure WS is turned into vapor. The evaporator of the invention is thus based on this evaporative cooling principle.

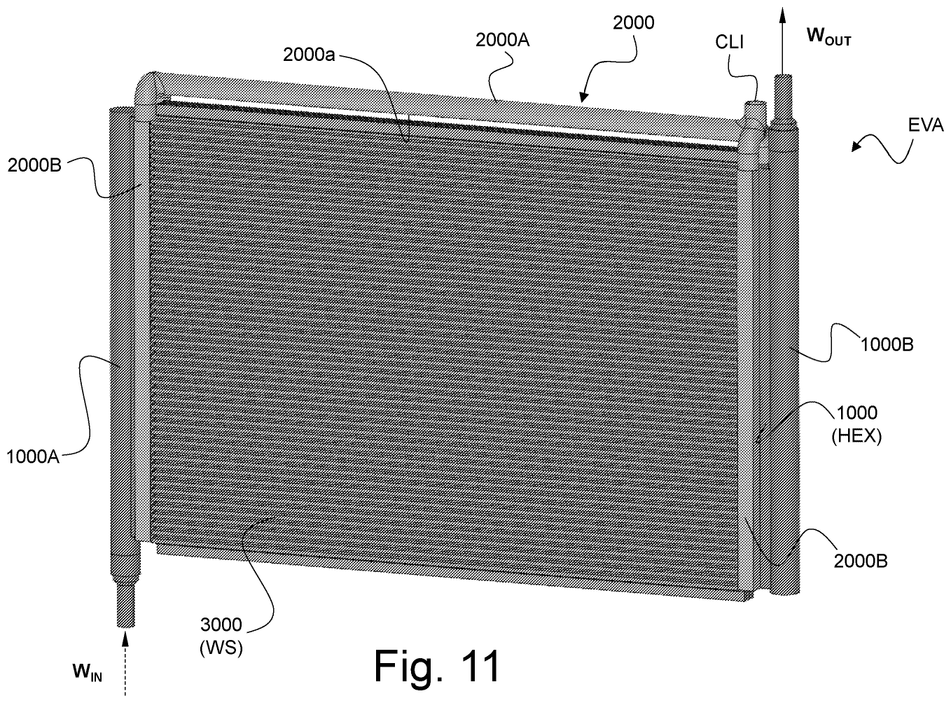

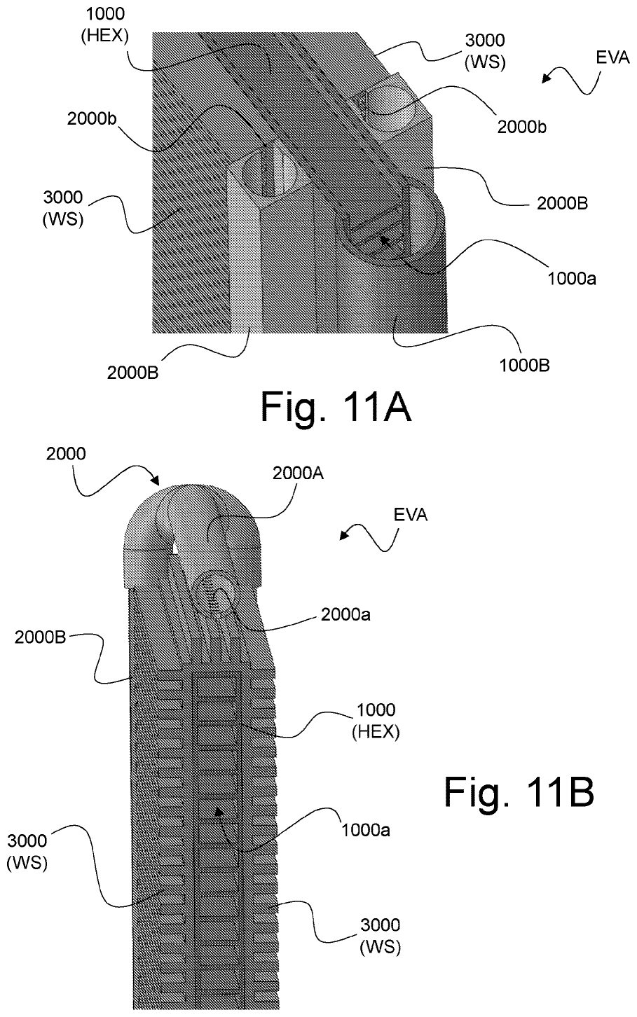

FIGS. 11 and 11A-B are schematic perspective views of an evaporator EVA in accordance with a preferred embodiment of the invention. Reference numerals 1000 and 3000 respectively designate the heat exchanger structure HEX and porous wick structure WS, while reference numeral 2000 generally designates the associated coolant dispensing system 2000.

In the illustrated example, the evaporator EVA is meant to be arranged in a vertical position as shown (but other arrangements could be contemplated, including in a horizontal position/orientation), and the heat exchanger structure 1000 (HEX) is coupled to a liquid inlet manifold 1000A and a liquid outlet manifold 1000B for circulation of the warm liquid W through the heat exchanger structure 1000 (HEX) from the warm liquid inlet W_{IN} to the cold liquid outlet W_{OUT}. More specifically, the heat exchanger structure 1000 (HEX) is structured to exhibit a plurality of channels 1000a, as shown in the cross-section of FIGS. 11A and 11B, which channels are distributed in the vertical direction.

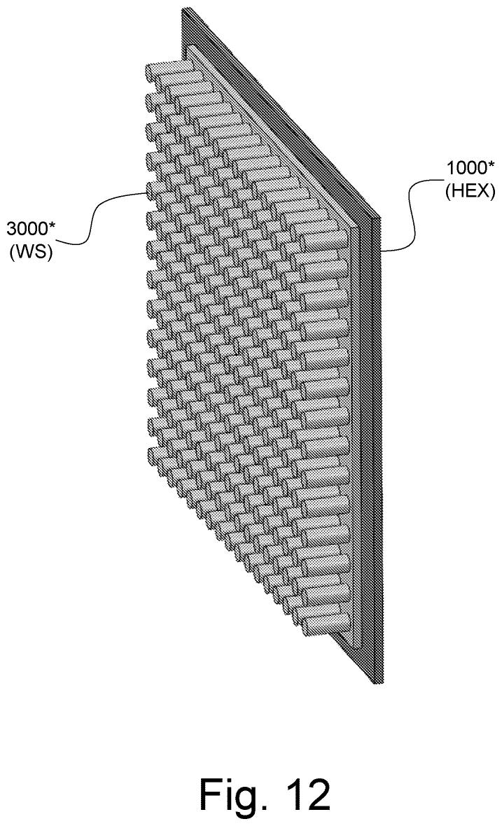

The porous wick structure 3000 (WS) is provided on either side of the heat exchanger structure 1000 (HEX), as well as on a top portion thereof, as shown in FIG. 11B. In the illustrated example, the porous wick structure 3000 (WS) is structured as a fin structure with multiple longitudinal fins as shown. The porous wick structure WS may however be structured in any other suitable manner. FIG. 12 for instance shows a porous wick structure 3000* (WS) provided on a heat exchanger structure 1000* (HEX), which porous wick structure 3000* (WS) is structured as a pin-fin structure with multiple pin-fins extending away from the heat exchanger structure 1000* (HEX). This alternate porous wick structure configuration is advantageous in that evaporative heat transfer area is increased, which favours evaporation efficiency. One will appreciate that other structures could be contemplated beyond the fin structure and pin-fin structures shown in FIGS. 11 to 12.

In the illustrated example, the coolant dispensing system 2000 advantageously includes an upper coolant dispenser 2000A positioned above the upper portion of the porous wick structure 3000 (WS) as well as two pairs of lateral coolant dispensers 2000B placed alongside lateral portions of the porous wick structure 3000 (WS). The liquid cooling medium is supplied to the coolant dispensing system 2000 at the coolant inlet CLI provided at the top right corner, as shown in FIG. 11. Advantageously, the upper coolant dispenser 2000A includes a plurality of drip holes 2000a populating a bottom part of the upper coolant dispenser 2000A, as shown in FIG. 11B, to drip-wet the upper portion of the porous wick structure 3000 (WS). Each lateral coolant dispenser 2000B, on the other hand, advantageously includes a longitudinal dispensing slit 2000b communicating with the relevant lateral portion of the porous wick structure 3000 (WS) along which it is placed, as shown in FIG. 11A.

The illustrated coolant dispensing system 2000 is sufficient for ensuring optimal wetting of the porous wick structure 3000 (WS) by capillary action. If required, additional wetting points could be contemplated by adding further longitudinal coolant dispensers along and in direct contact with the porous wick structure 3000 (WS).

The evaporator EVA shown in FIGS. 11 and 11A-B is one possible embodiment of an evaporator according to the invention, and other evaporator configurations could be contemplated. For instance, higher cooling power could be achieved by providing an array of multiple heat exchanger structures HEX arranged in parallel (whether in a vertical or horizontal orientation), with a common coolant dispensing system to suitably distribute the liquid cooling medium to wet each porous wick structure WS, as well as e.g. a common fluid supply to supply warm liquid to each heat exchanger structure HEX.

Various modifications and/or improvements may be made to the above-described embodiments without departing from the scope of the invention as defined by the appended claims.

For instance, while FIG. 4 shows an illustrative example of a quad-adsorber bed chiller system where first and second chiller modules, each including a pair of multi-stage adsorber devices, are operated in alternate adsorption-desorption cycles, one could perfectly contemplate to operate the relevant multi-stage adsorber devices in cascade where one adsorber device (e.g. AD1) completes the adsorption cycle before the other adsorber device (e.g. AD2) starts adsorption and, similarly, where one adsorber device (e.g. AD3) completes the desorption cycle before the other adsorber device (e.g. AD4) starts desorption. A partial overlap (e.g. a 50% overlap) of the adsorption and desorption cycles may also be contemplated.

More generally, the relevant adsorbers forming part of the multi-stage adsorber device of the invention may be configured and structured in any adequate manner. One particularly advantageous solution may especially consist in applying adsorbent material making up the adsorbers as coatings or layers directly onto the heat transfer structures and the heat exchanger tubes.

### LIST OF REFERENCE NUMERALS AND SIGNS USED THEREIN

10 multi-stage adsorber device
HS heating stage of multi-stage adsorber device 10
HT_{IN} heating fluid inlet of heating stage HS
HT_{OUT} heating fluid outlet of heating stage HS
S1-S5 adsorption stages of multi-stage adsorber device 10
AB adsorbers containing adsorbent material (e.g. packed silica gel or zeolites)
VC vapor chamber adjacent adsorber AB
HT heat transfer structure
CS cooling stage of multi-stage adsorber device 10
CL_{IN} cooling fluid inlet of cooling circuit CC, including cooling stage CS
CL_{OUT} cooling fluid outlet of cooling circuit CC, including cooling stage CS cooling circuit CC
CC1 first cooling section of cooling circuit CC (cooling of cooling stage CS)
CC2 second cooling section of cooling circuit CC (cooling of adsorbers AB)
TV1 throttle valve for selective coupling of second cooling section CC2 to first cooling section CC1
TV2 throttle valve for selective supply of vapor to adsorption stages S1-S5 (when used for chilling) or feeding of humid air to adsorption stages S1-S5 (when used for atmospheric water harvesting)
15 heating tube(s) extending through the adsorber AB of the first 15 adsorption stage S1
20A heat exchanger tube(s) extending through the cooling stage CS (part of first cooling section CC1 of cooling circuit CC)
20 heat exchanger tube(s) extending through each adsorber AB (part of second cooling section CC1 of cooling circuit CC)
100 chiller system (quad-adsorber bed chiller system)
200 chiller system (dual-adsorber bed chiller system)
300 atmospheric water harvesting (AWH) system (quad-adsorber bed AWH system)
400 atmospheric water harvesting (AWH) system (dual-adsorber bed AWH system)
500 combined chiller and atmospheric water harvesting (AWH) system (quad-adsorber bed chiller/AWH system)
AD1 multi-stage adsorber device/chiller device (FIGS. 4 and 8)/atmospheric water harvesting device (FIG. 6)
AD2 multi-stage adsorber device/chiller device (FIG. 4)/atmospheric water harvesting device (FIGS. 6 and 8)
AD3 multi-stage adsorber device/chiller device (FIGS. 4 and 8)/atmospheric water harvesting device (FIG. 6)
AD4 multi-stage adsorber device/chiller device (FIG. 4)/atmospheric water harvesting device (FIGS. 6 and 8)
AD_{A} multi-stage adsorber device/chiller device (FIG. 5)/atmospheric water harvesting device (FIG. 7)
AD_{B} multi-stage adsorber device/chiller device (FIG. 5)/atmospheric water harvesting device (FIG. 7)
RES coolant reservoir
VAC vacuum pump
RAD radiator for heat rejection (ambient)
TES thermal energy source (e.g. thermal energy produced by solar energy harvesting system or coming from industrial waste heat source)
EVA evaporator
SC space cooling
AAI ambient air intake (humid air intake)
BF blower fan
CT condensate tank
P1 pump for supply of cooling fluid from coolant reservoir RES
P2 pump for supply of heating fluid from thermal energy source TES
W warm liquid to be chilled (e.g. water for space cooling)
W_{IN} warm liquid inlet of evaporator EVA (space cooling)
W_{OUT} cold liquid outlet of evaporator EVA (space cooling)
WS (sintered) porous wick structure
HEX heat exchanger substrate/channelling of liquid to be cooled W
CLI coolant inlet for wetting of porous wick structure WS
1000 heat exchanger substrate/channelling of liquid to be cooled W
1000a channels for liquid to be cooled W
1000A liquid inlet manifold
1000B liquid outlet manifold
2000 coolant dispensing system
2000A upper coolant dispenser
2000a drip holes populating bottom part of upper coolant dispenser 2000A
2000B lateral coolant dispensers
2000b longitudinal dispensing slit provided along the side of lateral coolant dispensers 2000B
3000 (sintered) porous wick structure (fin structure)
1000* heat exchanger substrate
3000* (sintered) porous wick structure (pin-fin structure)

1.-60. (canceled)

61. A multi-stage adsorber device, comprising:
a plurality of adsorption stages distributed in sequence, each adsorption stage including an adsorber coupled to an adjacent vapor chamber, wherein the adsorber of each following adsorption stage is thermally coupled to the vapor chamber of a preceding adsorption stage via a heat transfer structure;
a heating stage thermally coupled to a first one of the adsorption stages to selectively provide thermal energy to the adsorbers;
a cooling stage thermally coupled to a final one of the adsorption stages to selectively cause condensation of desorbed vapor in the vapor chambers; and
a cooling circuit having a first cooling section to cause circulation of a cooling fluid through the cooling stage and a second cooling section to cause selective circulation of the cooling fluid through each of the adsorbers,
wherein, during a desorption cycle of the multi-stage adsorber device, the heating stage is activated to induce vapor desorption in the adsorbers resulting in desorbed vapor flowing from each adsorber into the adjacent vapor chamber,
wherein each heat transfer structure is configured to cause condensation of the desorbed vapor along a surface of the heat transfer structure, during the desorption cycle of the multi-stage adsorber device, such that latent heat resulting from the condensation of the desorbed vapor is transferred to the adsorber of the following adsorption stage,
wherein, during an adsorption cycle of the multi-stage adsorber device, the heating stage is deactivated to allow vapor adsorption into the adsorbers,
wherein the cooling circuit is configured to cause circulation of the cooling fluid only through the first cooling section during the desorption cycle of the multi-stage adsorber device,
and wherein the cooling circuit is further configured to cause circulation of the cooling fluid through both the first and second cooling sections during the adsorption cycle of the multi-stage adsorber device.

62. The multi-stage adsorber device according to claim 61, wherein the cooling stage and the adsorbers each include one or more heat exchanger tubes configured to allow circulation of the cooling fluid,
wherein the first cooling section of the cooling circuit is coupled to the one or more heat exchanger tubes of the cooling stage, and
wherein the second cooling section of the cooling circuit is coupled to the one or more heat exchanger tubes of each adsorber.

63. The multi-stage adsorber device according to claim 62, wherein the heat exchanger tubes are comprised of thin-walled fin tubes or plates-tubes.

64. The multi-stage adsorber device according to claim 61, wherein the cooling fluid is supplied at a temperature comprised between 50° C. and 60° C.

65. The multi-stage adsorber device according to claim 61, wherein the cooling fluid is water.

66. The multi-stage adsorber device according to claim 61, wherein the cooling circuit includes a throttle valve to selectively couple the second cooling section to the first cooling section during the adsorption cycle of the multi-stage adsorber device.

67. The multi-stage adsorber device according to claim 61, wherein the heating stage is coupled to a thermal energy source.

68. The multi-stage adsorber device according to claim 61, wherein the heating stage includes one or more heating tubes extending through the adsorber of a first one of the adsorption stages.

69. The multi-stage adsorber device according to claim 68, wherein the one or more heating tubes are flowed through by a heating fluid.

70. The multi-stage adsorber device according to claim 69, wherein the heating fluid is supplied at a temperature comprised between 90° C. and 95° C.

71. The multi-stage adsorber devices according to claim 61, comprising a sequence of n adsorption stages, n being an integer number comprised between 2 and 15.

72. The multi-stage adsorber device according to claim 61, further comprising a reservoir for collecting condensate formed in the vapor chambers of the adsorption stages during the desorption cycle of the multi-stage adsorber device.

73. A chiller apparatus comprising:
a multi-stage adsorber device according to claim 61 acting as chiller device;
a coolant reservoir to supply cooling fluid to the multi-stage adsorber device; and
an evaporator to supply vapor to the adsorption stages of the multi-stage adsorber device during the adsorption cycle of the multi-stage adsorber device.

74. The chiller apparatus according to claim 73, wherein the evaporator is coupled to the vapor chambers of the adsorption stages through a throttle valve that is selectively activated during the adsorption cycle of the multi-stage adsorber device to allow vapor to be supplied to the adsorption stages of the multi-stage adsorber device, and wherein the throttle valve is selectively activated during the desorption cycle of the multi-stage adsorber device to allow condensate forming in the vapor chambers of the adsorption stages to be collected in the coolant reservoir.

75. The chiller apparatus according to claim 73, wherein the evaporator comprises:
a heat exchanger structure configured to allow transfer of heat from a heat source;
a porous wick structure thermally coupled to the heat exchanger structure, which porous wick structure is configured to be wettable by the cooling fluid; and
a coolant dispensing system configured to wet the porous wick structure by means of the cooling fluid,
wherein the porous wick structure is structured to be partly exposed to vapor flow to cause part of the cooling fluid to evaporate.

76. The chiller apparatus according to claim 75, wherein the porous wick structure is a sintered porous wick structure provided, directly or indirectly, on the heat exchanger structure.

77. The chiller apparatus according to claim 75, wherein the porous wick structure has a porosity of 20% to 80%.

78. The chiller apparatus according to claim 75, wherein the porous wick structure exhibits pores having an average size comprised between 5 μm and 50 μm.

79. The chiller apparatus according to claim 75, wherein the porous wick structure exhibits a thickness comprised between 0.5 mm and 5 mm.

80. The chiller apparatus according to claim 75, wherein the porous wick structure is structured as a fin structure or as a pin-fin structure.

81. The chiller apparatus according to claim 75, wherein the heat exchanger structure is structured to include a plurality of channels to channel a warm fluid acting as the heat source.

82. The chiller apparatus according to claim 75, wherein the coolant dispensing system is configured to wet the porous wick structure by capillary action.

83. A chiller system, comprising:
a first chiller module and a second chiller module each comprising at least one multi-stage adsorber device in accordance with claim 61 acting as chiller device;
a coolant reservoir to supply cooling fluid to the first and second chiller modules;
an evaporator to selectively supply vapor to the first chiller module or the second chiller module; and
a radiator that is coupled to the coolant reservoir and to the evaporator for re-cooling of warm cooling fluid coming from the coolant reservoir,
wherein the chiller system is configured such that, when the first chiller module undergoes the adsorption cycle, the second chiller module undergoes the desorption cycle, and vice versa, and
wherein the chiller system is further configured such that:
cooling fluid is supplied from the coolant reservoir through the radiator to the first chiller module or the second chiller module depending on whether the first chiller module or the second chiller module undergoes the adsorption cycle;
cooling fluid is supplied from the coolant reservoir to the first chiller module or the second chiller module depending on whether the first chiller module or the second chiller module undergoes the desorption cycle;
cooling fluid is returned from the first chiller module and the second chiller module to the coolant reservoir;
vapor is supplied from the evaporator to the first chiller module or the second chiller module depending on whether the first chiller module or the second chiller module undergoes the adsorption cycle; and
condensate formed as a result of condensation in the first chiller module or the second chiller module, when undergoing the desorption cycle, is returned to the coolant reservoir.

84. The chiller system according to claim 83, wherein the first chiller module and the second chiller module each comprise an interconnected pair of said multi-stage adsorber devices.

85. The chiller system according to claim 83, wherein the first chiller module and the second chiller module each comprise a single said multi-stage adsorber device.

86. The chiller system according to claim 83, further comprising a thermal energy source that is selectively coupled to the first chiller module or the second chiller module depending on whether the first chiller module or the second chiller module undergoes the desorption cycle.

87. The chiller system according to claim 83, further comprising a low-pressure system to maintain the first chiller module and the second chiller module in a partial vacuum condition during adsorption and desorption.

88. The chiller system according to claim 87, wherein the low-pressure system comprises a vacuum pump that can selectively be coupled to the coolant reservoir and to the evaporator.

89. The chiller system according to claim 87, wherein pressure in the chiller system is maintained within a range of 1 to 8 kPa or less during adsorption and desorption.

90. An atmospheric water harvesting apparatus comprising:
a multi-stage adsorber device according to claim 61 acting as atmospheric water harvesting device;
a coolant reservoir to supply cooling fluid to the multi-stage adsorber device; and
an ambient air intake to feed humid air to the adsorption stages of the multi-stage adsorber device during the adsorption cycle of the multi-stage adsorber device.

91. The atmospheric water harvesting apparatus according to claim 90, wherein the ambient air intake is coupled to the vapor chambers of the adsorption stages of the multi-stage adsorber device through a throttle valve that is selectively activated during the adsorption cycle of the multi-stage adsorber device to allow humid air to be supplied to the adsorption stages of the multi-stage adsorber device,
and wherein the throttle valve is selectively activated during the desorption cycle of the multi-stage adsorber device to allow condensate forming in the vapor chambers of the adsorption stages to be collected in the coolant reservoir.

92. An atmospheric water harvesting system, comprising:
two or more multi-stage adsorber devices in accordance with claim 61 each acting as an atmospheric water harvesting device;
a coolant reservoir to supply cooling fluid to each multi-stage adsorber device;
an ambient air intake to selectively feed humid air to the multi-stage adsorber devices; and
a radiator that is coupled to the coolant reservoir for re-cooling of warm cooling fluid coming from the coolant reservoir,
wherein the atmospheric water harvesting system is configured such that only one of said multi-stage adsorber devices undergoes the desorption cycle at any given time, while all remaining multi-stage adsorber devices undergo the adsorption cycle, and
wherein the atmospheric water harvesting system is further configured such that:
cooling fluid is supplied from the coolant reservoir through the radiator to each multi-stage adsorber device undergoing the adsorption cycle;
cooling fluid is supplied from the coolant reservoir to the multi-stage adsorber device undergoing the desorption cycle;
cooling fluid is returned from the multi-stage adsorber devices to the coolant reservoir;
humid air is fed from the ambient air intake to each multi-stage adsorber device undergoing the adsorption cycle; and
condensate formed as a result of condensation in the multi-stage adsorber device undergoing the desorption cycle is returned to the coolant reservoir.

93. The atmospheric water harvesting system according to claim 92, comprising three or more said multi-stage adsorber devices.

94. The atmospheric water harvesting system according to claim 93, comprising a total of four said multi-stage adsorber devices forming a quad-adsorber bed arrangement.

95. The atmospheric water harvesting system according to claim 92, comprising a total of two said multi-stage adsorber devices forming a dual-adsorber bed arrangement.

96. The atmospheric water harvesting system according to claim 92, further comprising a thermal energy source that is selectively coupled to the multi-stage adsorber device undergoing the desorption cycle.

97. The atmospheric water harvesting system according to claim 92, further comprising a low-pressure system to maintain the multi-stage adsorber device undergoing the desorption cycle in a partial vacuum condition.

98. The atmospheric water harvesting system according to claim 97, wherein the low-pressure system comprises a vacuum pump that can selectively be coupled to the coolant reservoir.

99. The atmospheric water harvesting system according to claim 92, wherein the ambient air intake is coupled to a blower fan to force circulation of humid air through the adsorbers of the multi-stage adsorber device undergoing the adsorption cycle.

100. A combined chiller and atmospheric water harvesting system comprising:
a first pair of multi-stage adsorber devices in accordance with claim 61 acting as chiller devices and a second pair of multi-stage adsorber devices in accordance with claim 61 acting as atmospheric water harvesting devices;
a coolant reservoir to supply cooling fluid to each multi-stage adsorber device;
an evaporator to selectively supply vapor to one or the other multi-stage adsorber device of the first pair of multi-stage adsorber devices;
an ambient air intake to selectively feed humid air to one or the other multi-stage adsorber device of the second pair of multi-stage adsorber devices;
a radiator that is coupled to the coolant reservoir and to the evaporator for re-cooling of warm cooling fluid coming from the coolant reservoir; and
a condensate tank to collect condensate produced by each multi-stage adsorber device of the second pair of multi-stage adsorber devices,
wherein the combined chiller and atmospheric water harvesting system is configured such that, when one multi-stage adsorber device of the first pair of multi-stage adsorber devices undergoes the adsorption cycle, the other multi-stage adsorber device undergoes the desorption cycle and such that, when one multi-stage adsorber device of the second pair of multi-stage adsorber devices undergoes the adsorption cycle, the other multi-stage adsorber device undergoes the desorption cycle, and
wherein the combined chiller and atmospheric water harvesting system is further configured such that:
cooling fluid is supplied from the coolant reservoir through the radiator to each multi-stage adsorber device undergoing the adsorption cycle;
cooling fluid is supplied from the coolant reservoir to each multi-stage adsorber device undergoing the desorption cycle;
cooling fluid is returned from the multi-stage adsorber devices to the coolant reservoir;
vapor is supplied from the evaporator to that multi-stage adsorber device of the first pair of multi-stage adsorber devices which undergoes the adsorption cycle;
condensate formed as a result of condensation in that multi-stage adsorber device of the first pair of multi-stage adsorber devices which undergoes the desorption cycle is returned to the coolant reservoir,
humid air is fed from the ambient air intake to that multi-stage adsorber device of the second pair of multi-stage adsorber devices which undergoes the adsorption cycle; and
condensate formed as a result of condensation in that multi-stage adsorber device of the second pair of multi-stage adsorber devices which undergoes the desorption cycle is collected into the condensate tank.

101. The combined chiller and atmospheric water harvesting system according to claim 100, further comprising a thermal energy source that is selectively coupled to each multi-stage adsorber device undergoing the desorption cycle.

102. The combined chiller and atmospheric water harvesting system according to claim 100, further comprising a low-pressure system to maintain each multi-stage adsorber device of the first pair of multi-stage adsorber devices in a partial vacuum condition during adsorption and desorption, as well as that multi-stage adsorber device of the second pair of multi-stage adsorber devices undergoing the desorption cycle.

103. The combined chiller and atmospheric water harvesting system according to claim 102, wherein the low-pressure system comprises a vacuum pump that can selectively be coupled to the coolant reservoir and to the evaporator.

104. A method of carrying out multi-stage adsorption comprising the following steps:
(a) providing at least one multi-stage adsorption module designed to operate in alternate desorption and adsorption cycles, the multi-stage adsorption module including two or more successive adsorption stages each comprising an adsorber coupled to an adjacent vapor chamber, wherein the adsorber of each following adsorption stage is thermally coupled to the vapor chamber of a preceding adsorption stage via a heat transfer structure;
(b) operating the multi-stage adsorption module in the desorption cycle by supplying thermal energy to the adsorber of at least a first one of the adsorption stages to induce vapor desorption and taking thermal energy away from the adsorber of a final one of the adsorption stages to cause condensation of desorbed vapor, whereby desorbed vapor is released by each adsorber and flows to each adjacent vapor chamber where it condenses along a surface of each heat transfer structure, thereby releasing latent heat that is transferred to the adsorber of each following adsorption stage to sustain vapor desorption; and
(c) operating the multi-stage adsorption module in the adsorption cycle by ceasing all supply of thermal energy to the adsorber of the first one of the adsorption stages and taking thermal energy away from the adsorbers of all adsorption stages to cool the adsorbers and sustain adsorption.

105. The method according to claim 104, applied for the purpose of chilling or atmospheric water harvesting.

106. An evaporator, comprising:
a heat exchanger structure configured to allow transfer of heat from a heat source;
a porous wick structure thermally coupled to the heat exchanger structure, which porous wick structure is configured to be wettable by a liquid cooling medium; and
a coolant dispensing system configured to wet the porous wick structure by means of the liquid cooling medium,
wherein the porous wick structure is structured to be partly exposed to vapor flow to cause part of the liquid cooling medium to evaporate,
and wherein the heat exchanger structure is structured to include a plurality of channels to channel a warm fluid acting as the heat source.

107. The evaporator according to claim 106, wherein the porous wick structure is a sintered porous wick structure provided, directly or indirectly, on the heat exchanger structure.

108. The evaporator according to claim 106, wherein the porous wick structure has a porosity of 20% to 80%.

109. The evaporator according to claim 106, wherein the porous wick structure exhibits pores having an average size comprised between 5 μm and 50 μm.

110. The evaporator according to claim 106, wherein the porous wick structure exhibits a thickness comprised between 0.5 mm and 5 mm.

111. The evaporator according to claim 106, wherein the porous wick structure is structured as a fin structure or as a pin-fin structure.

112. The evaporator according to claim 106, wherein the coolant dispensing system is configured to wet the porous wick structure by capillary action.

113. The evaporator according to claim 106, wherein the coolant dispensing system includes an upper coolant dispenser placed above an upper portion of the porous wick structure, which upper coolant dispenser includes a plurality of drip holes populating a bottom part of the upper coolant dispenser to drip-wet the upper portion of the porous wick structure.

114. The evaporator according to claim 106, wherein the coolant dispensing system includes at least one lateral coolant dispenser placed alongside a lateral portion of the porous wick structure, which lateral coolant dispenser includes a longitudinal dispensing slit communicating with the lateral portion of the porous wick structure.
